(19) United States
(12) Patent Application Publication
(10) Pub. No.: US 2026/0350292 A1
(43) Pub. Date: Nov. 5, 2026

(54) Word-Pair Text Layout Methods and Systems for Enhanced Reading and Learning Using Word Pairs

(71) Applicant: Minghua Li, Austin, TX (US)

(72) Inventor: Minghua Li, Austin, TX (US)

(21) Appl. No.: 19/468,776

(22) Filed: Feb. 3, 2026

Related U.S. Application Data
(60) Provisional application No. 63/755,093, filed on Feb. 6, 2025.

(51) Int. Cl. G06F 40/106

(52) U.S. Cl. CPC G06F 40/106

(57) ABSTRACT

A method adapts publications containing unfamiliar vocabulary by inserting word pairs comprising target words and contextually-appropriate equivalents positioned to minimize visual disruption. Target words are identified and categorized according to reader vocabulary profiles as review words, should-remember words, read-and-go words, and learn-to-use words. Publications are adapted using relational target word networks that facilitate repeated exposure across related texts. A processor-implemented system identifies relational target words, generates word pairs, and creates adapted layouts for print or digital media. A strategy analysis subsystem optimizes adaptation parameters based on reader performance data. Hybrid local-cloud architecture supports real-time screen adaptation.

This application claims priority to U.S. Provisional Patent Application No. 63/755,093, filed Feb. 6, 2025, which is incorporated herein by reference in its entirety.

### BACKGROUND OF THE INVENTION

Artificial intelligence (AI) has revolutionized personalized learning through adaptive platforms, tutoring systems, chatbots, and analytics tools. Companies such as Carnegie Learning, Knewton, Third Space Learning, Cognii, Gradescope, Turnitin, BrightBytes, Civitas Learning, Duolingo, ELSA Speak, VIPKid, Rosetta Stone, Microsoft Learning Tools, and JAWS have developed solutions that analyze learner data to deliver customized content, feedback, and accessibility features.

Despite these advances, AI-enhanced learning remains constrained by traditional reading media, through which people absorb knowledge and information. Current approaches recombine existing media and content but fail to expand the fundamental “learning possibility region”—the capacity of media to deliver knowledge efficiently.

The media through which individuals absorb knowledge and information constitute their learning possibility region. While personalized learning, achieved by manipulating combinations of current media and content, can enhance an individual's learning effectiveness and comfort, it remains confined within the individual's existing learning possibility region.

Developing technologies to expand an individual's learning possibility region by changing and improving the media layout and content display, rather than just manipulating combinations of existing media and contents, is a crucial next step. This approach aims to enable learners to acquire more knowledge more efficiently and comfortably by expanding an individual's learning possibility region.

One significant change in this direction is the improvement of text layouts for reading, an area focused on transforming reading media. This innovation involves the invention of new text layouts and the development of devices necessary to implement these layouts. By doing so, learners' learning possibility regions can be expanded, and innovative devices can be developed to tailor to these enlarged limits of individuals' learning possibilities. This is just this invention called for.
Prior Art in Typesetting and Typography
Recent AI-driven developments include:
Readability Consortium (Adobe/Google/UCF): Machine learning for real-time typography optimization
Adaptive Typography: Dynamic font/layout adjustment based on user/environmental factors
BiRead Technology: One-click bilingual website conversion (100+ languages)
AI Font Generation: Few-shot complete fontset creation for multilingual layouts
Microsoft U.S. Pat. No. 10,664,938: Personalized font rendering per visual processing
IBM U.S. Pat. No. 10,896,258: Cognitive typography responding to engagement/emotion

These technologies advance readability but lack word-pair configurations for seamless bilingual/monolingual adaptation that maintains narrative flow while facilitating reading smoothness, effectiveness, and vocabulary acquisition.

This invention addresses these limitations through word-pair text layouts (“bilingual word pairs” and “monolingual pairs”) that enable smooth reading of complex publications by intermediate language learners, expanding the learning possibility region via media transformation rather than content recombination.

### SUMMARY OF THE INVENTION

1. Word pair (bilingual word pair and monolingual pair) text layouts providing smooth, natural, and flowing reading of publications containing unfamiliar vocabulary.
2. Methods utilizing word pair functionalities in text layouts to improve reading and vocabulary learning through word pair configurations in adapted publications.
3. Word-Pair Facilitated Reading-Based-Learning System Powered by AI (Basic System) laying out a perceptible presence of a network of relational target words in publication text of any language, creating adapted publications with word pairs to improve reading smoothness and learning effectiveness.
4. Word-Pair Facilitated Reading-Based-Learning Strategy Analysis and Recommendations Tool Powered by AI—a sub-system of the Basic System.
5. Hybrid architecture integrating local AI on reader devices and central cloud AI for the reading-based learning system.

### Discovery of Word Pair Text Layouts for Smooth, Natural, And Flowing Reading

What are the problems that prompt this invention as a solution to them?

Problem 1: Reading discomfort and significant time consumption caused by too many new words for those who have already acquired some level of a language yet still not competent enough to execute their wish to read in this language. This is true for many second language learners such as English as a second language learners (ELLs). This is also true for many junior first language readers who want to read in their first language but face difficulties in too many new words in the books that they want to read.

Many ELLs have already acquired a vocabulary of around 5,000 to 10,000 words such as many adults living, studying and working in the US. Their English is already considered very good, yet still feel headache when they read books like best sellers, news reports, journal articles, technical and legal document, or classic books, or even chat with an AI, caused by 5-10 new words in each page on their way of reading. 5-10 new words a page is not a small number. A 30-minute chat session could easily accumulate 100 new words. For a book of 300 pages, they may encounter more than 1,000 new words even if they just have 5 unrecognized words on each page, most of which may occur just once throughout the book. Most of these words rarely appear in their other readings during a year. Many people want to know the meanings of these words in the text as they want to understand fully what they are reading. Yet, using dictionary, even the most efficient way of using online dictionary such as just a click away in doing online reading, or using point reading dictionary, such interruptions can accumulate bad reading experiences and claim a lot of time, too much time that often inhibit them from further reading these publications. Just imagine a daily reading of 100 pages, how many such interruptions could happen and how much headache it could cause. What is more, as these words are rarely used and they may not see them more than ten times in their life time, which makes little sense trying to spend time to get familiar with these words for most of them. As such spending the time in dealing with such disruptions is just a waste of the time and experiences of hardships. Our innovation can make a difference.

Solution to Problem 1: Placing a native language equivalent by each of the estimated unrecognized English words in a position that does not distract the reader's eye focus from the flowing text to ensure a smooth flow of eye contact with what the reader is reading as the reader can get the meaning of an unknown word by reading through its equivalent in the reader's native language.

A combination of the unknown word in a text in the reader's second language and the equivalent in the reader's native language is named as bilingual word pair in this innovation. The purpose to form such bilingual word pairs in text in a second language to a reader is to overcome the reading disruption caused by unknown words for continuing smooth flow reading with the second language.

Here is one example of the text layout with bilingual word pairs that can smooth the English (can be other language as well) as a second language users to read a paragraph from Jane Austen's “Pride and Prejudice”.

Text Box 1: An original paragraph from Jane Austen's “Pride and Prejudice”.

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable, well-informed woman for the rest of her life; though, perhaps, it was lucky for her husband, who might not have relished domestic felicity in so unusual a form, that she still was occasionally nervous and invariably silly.

In the foregoing example, the words “amiable,” “relished,” and “felicity” are illustrative target words that may be associated with equivalents in a word pair layout.

An ELL who can read this book is already quite competent in English, yet still likely have some words he or she cannot recognize such as these three words: amiable, relished, and felicity. If a reader has to look up a dictionary for the three words in just one paragraph, it could be imagined that the reader would have to look up at least 500 words to read through the whole book. It could be estimated that the reader may spend 100% more of the reading time in looking up for understanding these unrecognized words, which might quickly exhaust the reader's interests in completing reading the book. Here is the example how we can layout the text with bilingual word pairs so that the reader will not be bothered by these unrecognized words.

Text Box 2: An adapted paragraph from Jane Austen's “Pride and Prejudice” for an ELL whose native language is Spanish with bilingual word pairs

Note: the three English words have all had their Spanish equivalents in parentheses

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable (amigable), well-informed woman for the rest of her life; though, perhaps, it was lucky for her husband, who might not have relished (disfrutado) domestic felicity (felicidad) in so unusual a form, that she still was occasionally nervous and invariably silly.

Text Box 3: An adapted paragraph from Jane Austen's “Pride and Prejudice” for an ELL whose native language is French with bilingual word pairs

Note: the three English words have all had their French equivalents in parentheses

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable (aimable), well-informed woman for the rest of her life; though, perhaps, it was lucky for her husband, who might not have relished (apprécié) domestic felicity (félicité) in so unusual a form, that she still was occasionally nervous and invariably silly.

Text Box 4.1: An adapted paragraph from Jane Austen's “Pride and Prejudice” for an ELL whose native language is Chinese with bilingual word pairs

Note: the three English words have all had their Chinese equivalents. Please note that the parentheses are removed as the Chinese character will not mix up with the English word easily in a pair.

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable [symbol] , well-informed woman for the rest of her life; though, perhaps, it was lucky for her husband, who might not have relished [symbol] domestic felicity [symbol] in so unusual a form, that she still was occasionally nervous and invariably silly.

Text Box 5: An adapted paragraph from Jane Austen's “Pride and Prejudice” for an ELL whose native language is Japanese with bilingual word pairs

Note: the three English words have all had their Japanese equivalents. Please note that the parentheses are removed as the Japanese character will not mix up with the English word easily in a pair.

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable [symbol] , well-informed woman for the rest of her life; though, perhaps, it was lucky for her husband, who might not have relished [symbol] domestic felicity [symbol] in so unusual a form, that she still was occasionally nervous and invariably silly.

Text Box 6.1: An adapted paragraph from Jane Austen's “Pride and Prejudice” for an native English speaker whose English level is still not quite high with monolingual word pairs

Note: the three English words have all had their simpler English equivalents in parentheses

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable (friendly), well-informed woman for the rest of her life; though, perhaps, it was lucky for her husband, who might not have relished (enjoyed) domestic felicity (happiness) in so unusual a form, that she still was occasionally nervous and invariably silly.

If the reader's first language is English but is a very young reader without as big vocabulary as high school seniors normally have, we may still insert a more frequently used word for the word in the text to make the reader have smoother reading.

So the logic behind bilingual word pairs will also work for native English readers without sufficiently big vocabulary to read many books. This can be the case for school students to read a lot of classics. In this case, the monolingual word pairs can be very much helpful to smooth reading experiences, which promotes reading. So for a text with some sophisticated words for certain level readers, tiered word pairs can be used to replace the sophisticated words so that the readers at that level may not be interrupted too much by many unknown words in the reader's first language.

This innovation is the discovery of bilingual word pairs and monolingual word pairs having the functionality of providing smooth reading experiences for second language learners or junior level of first language users. To put it simpler, we may combine the wording for bilingual word pairs and monolingual word pairs just as word pairs.

There can be variations of laying out the word pairs according to users' and/or adapters' preferences and choices. One variation is to use the equivalents to replace the new words. Here are two examples.

Text Box 6.2: A Variation to Text Box 6.1, an adapted paragraph from Jane Austen's “Pride and Prejudice” for an native English speaker whose English level is still not quite high using the equivalents to replace the unknown words in the text.

Note: the three original English words have all been replaced by their simpler English equivalents.

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, friendly, well-informed woman for the rest of her life; though, perhaps, it was lucky for her husband, who might not have enjoyed domestic happiness in so unusual a form, that she still was occasionally nervous and invariably silly.

Another example of this variation of laying out is below:

Text Box 6.3: A Variation to Text Box 4.1, An adapted paragraph from Jane Austen's “Pride and Prejudice” for an ELL whose native language is Chinese using the equivalents to replace the unknown words in the text.

Note: the three English words have all had their Chinese equivalents. The three original English words have all been replaced by their Chinese equivalents without parentheses to mark the replacement

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, [symbol] , well-informed woman for the rest of her life; though, perhaps, it was lucky for her husband, who might not have [symbol] domestic [symbol] in so unusual a form, that she still was occasionally nervous and invariably silly.

This variation using the equivalents to replace the original words can be a choice for users as long as they prefer. The logic behind this variation of using word pairs is the users' read preference if they so choose.

There can also be variations of equivalents. An equivalent can be a combination of words in one language or two depending on the needs. If a publication text is in the user's second language, there can be many variations of how an equivalent may comprised of. If needed for smoother reading and/or more efficient learning in a text of a publication in the user's second language, an equivalent can be a combination of words that may include words in the reader's or readers' second language and/or first language. Here is one example:

Text Box 6.4: A Variation to Text Box 4.1, An adapted paragraph from Jane Austen's “Pride and Prejudice” for an ELL whose native language is Chinese using the equivalents of a combination of a group words in both native and second language, and even some synonyms and antonyms for the purpose of more efficient learning.

HAPPY for all her maternal feelings was the day on which Mrs. Bennet got rid of her two most deserving daughters. With what delighted pride she afterwards visited Mrs. Bingley, and talked of Mrs. Darcy, may be guessed. I wish I could say, for the sake of her family, that the accomplishment of her earnest desire in the establishment of so many of her children produced so happy an effect as to make her a sensible, amiable (friendly: hostile: [symbol] ), well-informed woman for the rest of her life; though, perhaps, it was lucky for her husband, who might not have relished (enjoyed: disliked: [symbol] ) domestic felicity (happiness: Sadness: [symbol] ) in so unusual a form, that she still was occasionally nervous and invariably silly.

This variation of a new word's equivalent is a combination of a synonym and an antonym in the user's second language, and a synonym in the user's first language. There can be more variations so as to assist learning when needed.

Text Box 7: A variation of word pair for a reader whose first language is English, and second language is Chinese.

Xia [symbol] summer·tian [symbol] sky_summer de [symbol] of yī [symbol] one gè [symbol] a xià [symbol] below·wu [symbol] noon_afternoon, tiān [symbol] sky·qì [symbol] air_weather hen [symbol] very rè [symbol] hot. Nézhā [symbol] name yī [symbol] one gè [symbol] a rén [symbol] person lái [symbol] come dào [symbol] arrive Dōng [symbol] east·Hai [symbol] sea_seabottom biān [symbol] side wán [symbol] play. Hai [symbol] sea·shui [symbol] water_seawater hen [symbol] very lán [symbol] blue, hen [symbol] very piào [symbol] float·liang [symbol] bright_beautiful, tā [symbol] he kàn [symbol] see dào [symbol] arrive shui [symbol] water li [symbol] inside you [symbol] have hen [symbol] very·duō [symbol] many_many xiao [symbol] small yú [symbol] fish. This variation of a new word's equivalent is a combination of a synonym and an antonym in the user's second language, and a synonym in the user's first language. There can be more variations so as to assist learning when needed.

In this version, each word pair of a Chinese character is formed by three elements: Pinyin of the character, the character, and an English equivalent of the character such as “Xià [symbol] summer” and “tiān [symbol] sky”. For a word comprised by two or more characters, the word pair is “Xià [symbol] summer·tian [symbol] sky_summer”. With this word pair, a reader will be able to figure out the pronunciation of a Chinese character by its Pinyin in the first place of the word pair, and the character itself in the second place that helps to indicate the exact character that the Pinyin represents because a Pinyin may represent many different characters, and the English equivalent in the third place. If a word is comprised by two or more characters, the word pairs for all the characters will be combined by a dot between the two word pairs of the characters and then an English equivalent for the word will be placed at the end of the combined character word pair. One example is “Xià [symbol] summer·tian [symbol] sky_summer”.

### Discovery of Bilingual and Monolingual Word Pair Text Layouts for Word Repetition Through Natural Reading

Problem 2: Many people want to increment their vocabulary reservoirs in a well planned manner from their regular reading of books, news reports, journal papers, AI chat sessions, etc., but not to be dictated by the hardships due to their randomly encountered new words in regular reading. They want to limit the number of new words that they encounter during their regular reading that they want to manage to remember, and select the types of new words that they want to remember such as their average frequencies of appearances, the importance of remembering the words, etc. So these people want a regular reading experience of English media without the interruption caused by looking up the meanings of the new words, and at the same time want to accumulate some words from their daily readings according to their plan rather dictated by randomly encountered new words.

Solution to Problem 2: Besides using Solution to Problem 1 for smooth reading experiences, the need of planned vocabulary increase from daily reading can be optimized using personalized or tailored text layout with word pairs (bilingual or monolingual).

This innovation of bilingual word pairs will provide ELLs with opportunities to read a lot more in English so that they will have both daily motivations to read more but also to be able to be repeatedly exposed to the newly learned words in the process of interesting reading, which eventually naturalizes the words they have learned.

When we humans think, we often do so in some language. Each linguistic element, such as a word, carries inherent meaning. When learning English words, we initially attempt to associate them with meanings represented by descriptions in our native language, English or images of the objects. Upon encountering a new word, we tend to link it to something described in our first language, as this connection immediately reveals the meaning to us.

Merely memorizing a word involves associating its shape and sound with a meaning in our first language, but this doesn't grant the English word independent status in representing that meaning. A process is necessary to transform the word from being associated with native language equivalents to becoming a direct symbol representing the meaning itself.

This process involves using the word in numerous contexts, rather than just engaging in activities to memorize it through native language associations. This is why employing newly learned words in various contexts is a more effective method of acquisition of new words. Our approach of using word pairs encourages learners read a lot more with more interests, which provides a natural process of incorporating words to be repeated in reading contexts. This is what the scheme of laying out word pairs will function.

We might term this the “naturalization” process of an English word for a language learner. This cannot be achieved solely by memorizing the word in association with native language equivalents or representative images. Eventually, “apple” should simply mean apple, without the need to associate it with an image of apples or the native language word for apple.

A word can be considered well-learned when it has been fully naturalized in the learner's mind. This process of naturalization is crucial for effective reading comprehension. When a reader encounters a sentence or paragraph containing numerous unnaturalized words, understanding becomes difficult.

Reading extensively is the best way to naturalize the words just learned and to memorize new ones after the initial study process, which includes pronunciation practice and temporary memorization. The scheme of laying out word pairs in the reading text expedites both the processes of memorizing new words and naturalizing them by making extensive reading less hard, and in a given time, much more reading can be accomplished, which means that the reader can be exposed to a greater number of words due to more reading during the memorization and naturalization process. This is a process that the reader is exposed to same words repeatedly in the context of readings rather than in isolated word memorization process.

Using a personalized scheme of word pairs in text layout facilitates the process of memorizing new words so that memorizing new words is no longer tedious and hard to do. Using personalized data, the scheme of word pair text layout may differentiate three types of new words: newly learned words (review words), words to be learned (should-remember words), words not planned for immediate learning (read-and-go words). For the third category, the word pairs will allow the reader to smoothly and quickly read over these words, which will provide opportunity for the reader to read more so that the reader will get exposed to more repetitions of the “review” words, and “should-remember” words. Here is one example.

The bilingual word pair “read-and-go” mechanism releases readers from spending time on new words they don't need to memorize per their preferences, preventing boredom and negative feelings toward reading. This enables more continuous reading and thus greater overall word exposure compared to traditional methods. The mechanism replaces isolated word memorization activities with natural reading flow.

Through increased reading volume and repeated encounters with “should-remember” words, readers gain frequent natural exposure that effectively reduces the need for isolated memorization work.

### Methods for Bilingual and Monolingual Word Pair Implementation Promoting Natural Reading and Word Repetition

Our methods are innovated to optimize word pairs in text layout so that readers will have personally optimized reading and learning experiences and processes and results.

In what follows, the term publications and books are often used interchangeably for easier understanding and writing, but what is specified for books is all relevant to publications unless specifically specified otherwise.

We will also assume all the publications are in English, and the users are all ELLs for convenience, yet what is specified below is also relevant to publications in other languages, and users of any first and second languages.

Methods for Personalized Adapting of Standalone Publication Layouts with Word Pair Configurations

Such publications can be paper media or electronic media; books, journal papers, or news reports; simple ones for junior second language readers or advanced ones for senior readers. The purpose of word pair text layout is smooth reading for target readers.

Below are steps for adapting current publications-suitable for books, journal papers, news reports, and AI chat results.

For all publications, first check copyright status. If copyrighted, obtain permission for word pair text layout adaptation. This requirement applies throughout the document and will not be repeated.

This method adapts standalone publications without consideration of relationships to other publications. It is tailored to individual readers' preferences.
4.1.1 Step 1: Determine the target user for the adapted book, including: the user's reading vocabulary stock in the language of the book's text, the user's first and/or second language, and whether the language of the book's text is the user's first or second language. There are multiple applicable ways to determine the user's vocabulary stock.
4.1.1a If the user has a complete record of his or her reading vocabulary stock, including all words the user can recognize in reading and the total number of these words, this record can be used as an estimate of the user's vocabulary stock. In practice, such a complete record is uncommon.
4.1.1b Established tests such as Prolingua Vocabulary Estimator, TestYourVocab, VocabularySize.com, English Vocabulary Level Test (Oxford Online English), and Vocabulary.com provide preliminary vocabulary size estimates suitable as starting points for adapting a book with word pairs. Precision is unnecessary; approximate estimates suffice despite potential 10% error. The book adapter uses an estimate 10% below the average of multiple assessment tools. For example, an average of 5,000 words yields a vocabulary stock estimate of 4,500 words (5,000×0.9). This conservative method slightly overestimates unknown words (false negatives) while minimizing false positives (unknown words marked known). If the adapter flags 10 words per page as unknown but the user knows one, no negative experience results—the user skips it. Conversely, an unidentified unknown word requires manual lookup, disrupting reading flow.
4.1.2 Step 2: Now that the user's estimate of vocabulary stocks is done, the book adapter should find an appropriate book for the user. Among all the considerations for selecting the book, the most important is to find one book that is suitable for a user with the estimated vocabulary stocks. Normally a book with about 5-10 new words a page will be appropriate for ELLs. In practice, the user should have a say in making the selection of a book, and he or she may specify an approximated number of new words on one page of the book. Thus, the book can be selected.
4.1.3 Step 3: Identify all new words and their frequencies in the book. This is done more easily with a database and program called a “mini system.” The book's text is stored in one table and the user's vocabulary stock in another. The process involves: (1) tokenizing the text into individual words; (2) removing punctuation and converting to lowercase; (3) comparing each word against the user's vocabulary stock, flagging unmatched words as new; and (4) counting each new word's frequency.

Note: While AI tools can identify new words for readers with known vocabulary reservoirs, current AI cannot reliably perform this task. The traditional database/program approach above is therefore recommended.
4.1.4 Step 4: Dividing the new words into “should-remember” words and “read-and-go” words. “should-remember” words are what the user will try to remember through the process of this learning based on reading the book. The number of new words that is categorized as “should-remember” words is determined by the users. If the user does not want to do work to remember new words, he or she may set the number of “should-remember” words as zero. It is recommended to select the words with higher frequencies in the book to be the “should-remember” words so that the repetitions of these words in the book will help the user to get exposed to them frequently to enhance memorization of them. The rest of the new words are “read-and-go” words meaning that the word pairs for these words will just facilitate the user to read through so that the reading of the book will be smoother but the user does not need to do further work to remember these words. Alternatively, the user may select certain number of the most frequently used words in the new word list as “should-remember” words, and put the rest of the new words into “read-and-go” word list.
4.1.5 Step 5: Creating a list of word pairs for all the new words. A word pair is a combination of a new word and its equivalent in the context of the book. The equivalent is a known word or phrase that helps explain the meaning of the new word. This pairing is designed to assist the user in understanding and learning new vocabulary within the context of the book. There are many ways to find out equivalents to all the new words in the book. One way is to manually give equivalents to all the new words by relevant language experts, which could be very much costly. Another way is to use an AI, which is recommended as AI services are widely available today. The book adapter can send the list of new words to an AI, such as chatGPT, and then divide the book into several parts with each part small enough for an AI to accept and be able to work on it. Then the adapter can send the book one part at a time asking the AI to give each new word from the list of new words an equivalent according to the context in the book that is sent to the AI one part after another. Prompt the AI to consider two scenarios: if the book text is in the user's first language, both the equivalents and new words will be in the first language. However, the equivalents will be words known to the user, while the new words are new. If the book text is in the user's second language, the equivalents will be provided in the user's first language. There can be many variations of how an equivalent may comprised of. If needed for smoother reading and/or more efficient learning in a text of a publication in the user's second language, an equivalent can be a combination of words that may include words in the reader's second language and/or first language. Ask the AI to give a list of word pairs with the new words and their equivalents for further work. The adapter can send all parts of the book to the AI and finally get a file with all the new words and their equivalents, which contains the list of word pairs.
4.1.6 Step 6: Identifying “learn-to-use” words based on the reader's learning strategy. “learn-to-use” words are words and phrases extracted from the book that are considered valuable for the user to master as active words that the user will be able to use them in aural and written communications. The user is to provide criteria what words and phrases from the book should be extracted as “learn-to-use” words and the number of them. Again, a very costly way to do this is to ask a language expert to select these words for the user. A better way is to use AI services. Using the same way as in
4.1.5 Step 5 that sends the book in parts one by one to the AI, and give the AI prompt with the criteria for selecting “learn-to-use” words and the number of them from the book, asking the AI to extract these words and give back lists of “learn-to-use” words as responses.
4.1.7 Step 7: Determining which new words should be replaced by the corresponding word pair. The easiest way to do this is to replace all the new words with their corresponding word pairs. There could be better ways to do this. One way is to intermittently replace the repeated new words in the book with their word pairs with the user's choice, which could be better for the user to learn and remember the words. When a “should-remember” word appears in the book a few times, it makes sense sometime the word is just marked as “should-remember” word with some color without its equivalent by its side, which stimulates the user to think and confirm he or she has temporarily remembered the word. If the user does not recognize it, that would be the time that the user read it for a few more times and tries again to remember it. As for the “read-and-go” words, the user is not planning to purposefully remember them and so they would all be replaced by their word pairs so that the user can read the book smoother and quicker. The user should select how to intermittently replace the repeated new words in the book with their word pairs, every other occurrence of the new word or some other way. With a sophisticated way of intermittently use word pairs to replace their corresponding new words in the text of a book will boost the user's ability to remember the words in the process of reading. To execute the user's choice of intermittently use word pairs to replace their corresponding new words, one way is to categorize all locations with new words in the text into two groups, in one group the new words will be replaced by their corresponding word pairs, called word pair locations; in other group no such replacement will happen, called no word pair location, which is like a map of positioning of the word pairs in locations of the text.
4.1.8 Step 8: Replacing the new words at word pair locations in the text with corresponding word pairs, wherein: each word pair comprises a new word and its equivalent; the equivalent is positioned relative to its paired new word according to a word pair layout logic, wherein the position is selected from immediately after, immediately before, directly above, or directly below the target word according to the user's choice so that the positioning of the equivalents and the formatting of the word pairs are designed to minimize disruption to the user's visual flow of the text.
4.1.9 Step 9: Laying out the text to create a perceptible presence of a network of word pairs in physical print or electronic media of the said adapted book, wherein:
4.1.9a word pairs are visually designated according to a word pair marking logic as selected by the user;
4.1.9b new words at non-word pair locations are distinctly marked based on the user's choice;
4.1.9c the marking methods may include, but are not limited to: color highlighting; underlining; bold or italic formatting; font size or type changes; leaving words unmarked as appropriate; same word in different positions may have different marks.
   Method for Adapting Standalone Publication Layouts with Word Pair Configurations (Bilingual or Monolingual) for Tailored Group Users

Now is the specification of the method for adapting such a standalone book, not for one user in personalized manner, but for a group of users who have similar proficient level of the language of the book for adaptation. This method is especially useful for publishers who publish such adapted books targeting not just one user but many, the tailored groups, each of which have similar proficiency level of the language.
4.2.1 Step 1: Determine the target group users the adapted book is for, this group users' reading vocabulary stocks of the language of the text of the book, the users' first and/or second language, and if the language in the text of the book is the users' first or second language. There can be quite a few applicable ways to determine a group users' vocabulary stocks.
4.2.1a If the group users have a complete record of their reading vocabulary stocks including all the words that the users can recognize in reading and the number of these words, then this record can be used as an estimated vocabulary stocks of the group users. Quite often this is the case, such as for certain grade students that it is easy to get their estimates of vocabulary stocks by looking at their schooling records and curriculum. Besides, some public language tests, such as Junior TOEFL, TOEFL, GRE, can also help to group users into tiers of language proficiency levels, which helps to setup target groups for publishers to do the adaptation of the books with word pairs.
4.2.1b Use some word testing methods to estimate users' vocabulary stocks so as to differentiate them into different similar level groups by grouping according to their vocabulary stock estimates. So each user may do their own tests and group them according to their estimates of vocabulary stocks. There are some established tests to use to get some preliminary estimated vocabulary stocks. Prolingua Vocabulary Estimator, for example, can assess a user's reading vocabulary and provide an estimate of the user's overall vocabulary size. There are more such vocabulary size estimators, such as TestYourVocab, VocabularySize.com, English Vocabulary Level Test (Oxford Online English), Vocabulary.com. It is not intended to obtain a precise measurement of a user's vocabulary stocks, but rather to provide a reasonable starting point for adapting a book with word pairs for the users. While a 10% estimation error may seem significant, its impact on personalizing a book with word pairs is minimal. In practice, it is advisable for a book adapter to use an estimate that is 10% lower than the average of vocabulary estimates from various vocabulary assessment tools for users for grouping purpose. For instance, if the average estimated vocabulary size is 5000 words for a group of users, the book adapter might consider this group of users to have a vocabulary stock of 5000*0.9=4500 words. This conservative approach increases the likelihood that the book adapter will slightly overestimate the number of unknown words that are actually known to the users, but rarely categorize unknown words as known to the users.
4.2.2 Step 2: Now that the users are grouped according to their estimated vocabulary stocks, and each group of users has a clear estimate of vocabulary stocks for all the users in the group, the book adapter should find an appropriate book tailored to this group users. Among all the considerations for selecting the book, the most important is to find one book that is suitable for the group of users with the estimated vocabulary stocks. Normally a book with about 5-10 new words a page will be appropriate for ELLs.
4.2.3 Step 3: Finding all the new words and their frequencies in the book based on the estimated vocabulary stocks for the group of the users. This can be done easier with a database and a program, which we may call a mini system. The book's text is stored in a table, and the user's vocabulary stocks in another table. The process of identifying new words and determining their frequency in a book involves the following steps: The system tokenizes the book's text into individual words. It removes punctuation and converts all words to lowercase for consistent comparison. The system compares each processed word against the users' vocabulary stocks, words not found in the users' vocabulary stocks are flagged as new words. Frequency Calculation: as the system processes each word, it maintains a count of how many times each new word appears in the book. This count is updated each time a new word is encountered. Thus, a list of new words and their frequencies in the book is identified.
4.2.4 Step 4: Dividing the new words into “should-remember” words and “read-and-go” words. This step is the same as “4.1.4 Step 4”, except for using group users rather than an individual user to show the differences between a group of users versus a single user. There is another difference: the number of new words that is categorized as “should-remember” words is NOT determined by the users as this is an adapted book tailored to the group of users and so the adapter must estimate the appropriate number and make a decision on it. If this group of users are actually quite different on the number of words to be categorized as “should-remember” words, the adapter may consider to develop two or more versions of the adapted book with different numbers of words to be categorized as “should-remember” words.
4.2.5 Step 5: Creating a list of word pairs for all the new words. This step is the same as “4.1.5 Step 5”, except for using group users rather than an individual user to show the differences between a group of users versus a single user.
4.2.6 Step 6: Identifying “learn-to-use” words based on the reader's learning strategy. This step is the same as “4.1.6 Step 6”, except for using users rather than user to show the differences between a group of users versus a single user. There is another difference: instead of the users, the book adapter is to provide criteria what words and phrases from the book should be extracted as “learn-to-use” words and decide the number of them.
4.2.7 Step 7: Determining which new words should be replaced by the corresponding word pair. This step is the same as “4.1.7 Step 7”, except for using users rather than user to show the differences between a group of users versus a single user. There is another difference: instead of users, the book adapter is to decide the map of positioning of the word pairs in locations of the text.
4.2.8 Step 8: Replacing the new words at word pair locations in the text with corresponding word pairs. This step is the same as “4.1.8 Step 8”, except for using users rather than user to show the differences between a group of users versus a single user. There is another difference: instead of users, the book adapter is to decide the positioning of the equivalents by the new words.
4.2.9 Step 9: Laying out the text to create a perceptible presence of a network of word pairs in physical print or electronic media of the said adapted book. This step is the same as “4.1.9 Step 9”, except for using users rather than user to show the differences between a group of users versus a single user. There is another difference: instead of users, the book adapter is to decide the marking logic and make the choices.

This completes the specification of the method for adapting of standalone publication layouts with word pair configurations (Bilingual or Monolingual) for tailored group users

Method for Adapting Series of Publications with Word Pair Configurations (Bilingual or Monolingual) for Individual And/or Tailored Group Users in Long-Term Reading Contexts

This method for individual user and tailored group users is essentially the same, and so we just specify the method for tailored group users, which is applicable to individual users with personalized arrangements.

There are needs to develop a systematic series of books with the word pair text layouts. With series of books tailored to a group of users at the same level of language competency, some relationships among the books in a series can be used for better facilitating learning with word pairs for long-term learners.

Suppose the first book in the series is the first book of the Boxcar Children Series. We may target for ELLs who have already had around 1,000 English words for reading as their vocabulary stocks. We may find out a list of new words for this book for the users, say 500 new words. We then divide these 500 words into two parts: 100 should-remember words, and 400 read-and-go words. The users entering into this reading would have some variations in their vocabulary size. We know all those who have read the first book with our text layout will have learned 100 words. Suppose in the second book, 80 of these 100 should-remember words will appear, and there is another set of 100 should-remember words and 300 read-and-go words. In selecting this set of 100 should-remember words, efforts should be paid to include many of the 400 “read-and-go” words for the previous book that may have quite some appearances.

From this scenario, we can see two relations between the books that we can take advantages of when using the word pairs. First, some “should-remember” words in the first book will appear in the second book, which is a quite natural way to review these words. So we can pick up these words that are “should-remember” words in earlier book and also are present in the second book as “review” words.

Secondly, some of the “read-and-go” words for the previous book may have quite some still appearing in the current book. If we include such words in the list of the “should-remember” words for the current book, the users would have much easier work to remember them as they are exposed to these words in the earlier book.

Thirdly, as the time goes on when the group of users with the same level of language competency read more books with this group reading, the users' vocabulary stocks tend to merge to be the same. We can go on and on for more and more books in this reading series and to some point, the vocabulary reservoirs of the users who have read this series for a while would be about the same and therefore, we would have reached a point of quasi-personalized solution without the cost of using some type of database to track each user.

Fourthly, yet the most important of all is the concentration of significant amount of new words among the books that the users will read in adjacent time points one after another. The concentration of the same words among books refers to the phenomenon where specific words frequently appear across multiple books, creating a shared vocabulary that can significantly enhance the users' memorizing of them as they occur again and again. This concentration indicates that certain words are common in related texts, which can help users reinforce their understanding and retention of new vocabulary. When users encounter the same words in different contexts, it allows them to make connections and deepen their comprehension. This shared presence of vocabulary across various books not only aids in language acquisition but also supports the development of a more cohesive reading experience, as learners can build on their knowledge progressively by engaging with familiar terms in diverse settings.

We can easily develop a 5-year book reading series with this bilingual word pair layout text with tiered progressive readings. All the users may have accumulated 10,000 words using this book series on reading-based English learning. More such systematic book series can be designed and published using the same method of tiered yet adaptive systematic word pair text layout to accommodate different starting levels and different reading interests of readers.

Here are the steps to execute the method for adapting of a series of Publications with Word Pair Configurations (Bilingual or Monolingual) for a tailored group users for Long-Term Reading
4.3.1 Step 1: Determine the target group users this series of adapted books is for, primary this group users' reading vocabulary stocks of the language of the text of the books at the starting point of joining this group reading, the users' first and/or second language, and if the language in the text of the books is the users' first or second language. There can be quite a few applicable ways to determine a group users' starting vocabulary stocks.
4.3.1a The same as “4.2.1a”.
4.3.1b The same as “4.2.1b”.
4.3.2a Step 2a: Now that the users are grouped according to their estimated starting vocabulary stocks, and each group of users has a clear estimate of vocabulary stocks for all the users in the group, the series book adapter should find a set of books tailored to this group users. Among all the considerations for selecting the books, the most important is to find the books that are suitable for the group of users with the estimated starting vocabulary stocks, especially suitable for progress from that point. Normally a book with about 5-10 new words a page will be appropriate for the users, which actually mean that the books will be progressive in terms of vocabulary as well as reading difficulties.
4.3.2b Step 2b: Trying the best to select books that have high concentration of common words that the new words from previous book would have high percentage of occurrences in the following books for long-term reading-based learning, the method can be applied that comprises:
4.3.2b.1: the books have a gradual increase in vocabulary difficulty and comprehension level,
4.3.2b.2: the books are intended for use over coming months and years,
4.3.2b.3: priority is given to books with higher concentrations of “should-remember” words from immediate earlier books in the set, thereby facilitating review of recently learned words;
4.3.2b.4: compiling the selected books into a relational book set.
4.3.3 Step 3: Finding the new words and their frequencies in the first book of the relational book set based on the estimated vocabulary stocks for the group of the users. The step specified in “4.2.3 Step 3” will apply here.
4.3.4 Step 4: Continue to work on just the first book of the relational book set to divide the new words into “should-remember” words and “read-and-go” words. The step specified in “4.2.4 Step 4” will apply here.
4.3.5 Step 5: Continue to work on just the first book of the relational book set to create a list of word pairs for all the new words. The step specified in “4.2.5 Step 5” will apply here.
4.3.6 Step 6: Continue to work on just the first book of the relational book set to identify “learn-to-use” words based on the reader's learning strategy. This step is the same as “4.2.6 Step 6”.
4.3.7 Step 7: Continue to work on just the first book of the relational book set to determine which new words should be replaced by the corresponding word pair. This step is the same as “4.2.7 Step 7”.
4.3.8 Step 8: Continue to work on just the first book of the relational book set to replace the new words at word pair locations in the text with corresponding word pairs. This step is the same as “4.2.8 Step 8”.
4.3.9 Step 9: Continue to work on just the first book of the relational book set to lay out the text to create a perceptible presence of a network of word pairs in physical print or electronic media of the said adapted book. This step is the same as “4.2.9 Step 9”.
4.3.10 Step 10: Now starting to work on the second book of the relational book set. When a second book of the relational book set has been selected, there will be a new category of words called “review” words for the second book, which means that in the process of using the second book for doing reading-based-learning, the users will be facilitated to review the “review” words. The “review” words must be at present in both the first and the second book of the set. Most of the “review” words are from “should-remember” words in the first book. If this is not the second book of the set, but a third or fourth or fifth book of the set, some “review” words from the earlier books will also be selected into the current book's “review” words so that the current “review” words will facilitate the reviewing of the words acquired in reading the earlier books. Some of the “review” words from the second book are selected from the “read-and-go” words of the first book for the purpose to facilitate users to accumulate words from “read-and-go” words in the earlier book reading. Again, these words must be at present in both the second and the first book. For the subsequent books in the set, the “review” words of the current book will contain some words that are “read-and-go” words in the previous book in the set. After the determination of the “review” word, “should-remember” words, and “read-and-go” words for the second book of the set, the rest of steps will be the same as the first book of the set as describe above in this sub-section.
4.3.11 Step 11: Now working on the subsequent books of the relational book set after the second book. The subsequent books of the set will have similar steps as the second book, but the difference is that the “review” words for a book can come from not only the previous one book, but also more of earlier books of the set. The rest of steps for these subsequent books will be the same as the second book of the set as describe above in this sub-section.
4.3.12 Step 12: This step should start from just the beginning, yet would finally wrap up the selection and adaption of a relational set of books as a series. Normally, a set should allow the users to read them for about half a year, one year, could be a little bit longer, but one year should be normally long enough to design a cohesive book set for the users.

The steps in this sub-section also applies to adapt a series of publications with word pair configurations (bilingual or monolingual) for individual user for long-term reading.

This completes the specification of the method for adapting of a series of publications with word pair configurations (bilingual or monolingual) for individual user and/or tailored group users for long-term reading

### Word-Pair-Facilitated Reading-Based Learning System Powered by AI (Basic System)—A Database-Driven System for Optimizing Reading and Vocabulary Acquisition Through A Perceptible Network of Relational Target Words and Word Pairs in Publications

S1 Overview of the System

The Reading-Based Learning System Powered by AI is an advanced cloud-based platform leveraging open AI services to implement a method of laying out relational target words in publications, creating adapted publications with word pairs. This system aims to improve reading smoothness and learning effectiveness across languages. The system offers three modes:
Single publication mode for individual reading
Relational publication set mode for structured, long-term learning with repeated exposure to new words
Group reading mode for collaborative learning and resource efficiency
User Experience and Interface:
Web-based interface with customizable text display settings
Interactive features including word highlighting and annotation tools
Adapted text display with adjustable word pairs
Comprehensive review word list functionality
Reading Manager Interface:
Dashboard with analytics and performance metrics
User and publication management tools
Relational publication set creation and modification
Progress tracking and detailed reporting
Key Features:
Organized layout of relational target words
Long-term learning support through curated publication sets
AI integration (e.g., GPT, Llama, PaLM) for sophisticated text analysis and adaptation
Multilingual support and service flexibility
AI-Powered Tools:
New words test for vocabulary development
Reading comprehension test
Oral presentation and evaluation tool with automated transcription
Writing evaluation tool for skill enhancement
S2 System Architecture

The system employs a cloud-based architecture with the following components:
S2.1 User Interface (UI): Web-based front-end for user and manager interactions, providing access to all system functionalities based on user roles and permissions, including management of publications, prospective publications, and relational publication sets.
S2.2 Application Logic: Cloud-hosted backend services.
S2.3 Database: Cloud-hosted database for user data, publications, adaptations, and recorded words.
S2.4 AI Integration: Utilizes cloud-provided AI services (e.g., OpenAI's GPT models, Meta's Llama models, Google's PaLM).
S3 Cloud Solution

The system can be deployed on major cloud platforms such as Amazon Web Services (AWS), Google Cloud Platform (GCP), or Microsoft Azure. The choice of cloud provider will depend on factors such as cost, available AI services, and specific project requirements.
S4 Database Design
The system uses a cloud-hosted relational database with the following tables:
S4.1 Users
UserID (Primary Key): Unique identifier for each user
Name: User's full name
VocabularyLevel: Current vocabulary proficiency level of the user, using ranked indicators for the levels
LearningStrategy: reading preferences and goals, including weekly time commitment, reading volume targets, word increase targets, and book type preferences
FirstLanguage: User's native language
SecondLanguage: User's secondary language (if applicable)
IsCurrentPublicationFirstLanguage (Boolean): Indicates if the language of the current publication is the user's first language
VocabularyStocks (Array or JSON field): List of known words in the primary reading language, including all words and the total word count
WordPairOccurrencePattern (Integer, default: 2): User's preference for how often word pairs should appear
EquivalentInWordPairPositionPreference (String): User's preference for an equivalent positioned versus the corresponding word in a word pair (‘after’, ‘before’, ‘above’, ‘below’, or ‘auto’)
WordPairFormattingPreference (JSON or structured format): User's preferences for word pair visual formatting; if preferred by the reader or readers, each word pair for the “read-and-go” words that only contains its equivalent without the corresponding “read-and-go” word;
DesiredReviewWordCount (Integer, default: 50): Number of review words the user wants to see
MarkingStylePreference (JSON or structured format): User's preferences for how target words and word pairs are visually marked
CognitiveLoadTolerance (String): User's tolerance for visual complexity in adapted texts
PreferredLearningPace: User's preferred pace for learning new words (“should-remember” words)
LongTermLearningGoals: User's long-term learning objectives
DefaultMode (String): User's preferred operational mode (‘single’, ‘relational’, or ‘group’)
S4.2 PublicationLibrary
PublicationID (Primary Key): Unique identifier for each publication
Title: Title of the publication
Author: Author(s) of the publication
FullTextContent: Complete text of the publication
Language: Language of the publication
PublicationDate: Date the publication was released or added to the system
DifficultyLevel: Assessed difficulty level of the publication (such as Lexile Ranks)
S4.3 AdaptationLevels
LevelID (Primary Key): Unique identifier for each adaptation level
LevelName: Name or description of the adaptation level (e.g., ‘Beginner’, ‘Advanced’)
S4.4 PublicationAdaptations
AdaptationID (Primary Key): Unique identifier for each adaptation
PublicationID (Foreign Key to PublicationLibrary): Reference to the original publication
LevelID (Foreign Key to AdaptationLevels): Reference to the adaptation level
AdaptedPublications (Text or BLOB): The adapted version of the publication
LastUpdated: Timestamp of when the adaptation was last modified
WordTest: JSON or structured format storing the generated word test
S4.5 UserReadingProgress
ProgressID (Primary Key): Unique identifier for each reading progress entry
UserID (Foreign Key to Users): Reference to the user
PublicationID (Foreign Key to PublicationLibrary): Reference to the publication being read
ShouldRememberWords (Array or JSON field): List of “should-remember” words identified for this user and publication
ReadAndGoWords (Array or JSON field): List of “read-and-go” words identified for this user and publication
ReviewWords (Array or JSON field): List of words selected for review
ValuableWordsAndPhrases (Array or JSON field): List of Y number of “learn-to-use” words and phrases from the publication, set by the user
LastReadPosition: User's last reading position in the publication
LastReadDate: Date and time of the user's last reading session for this publication
TestScores: Array or JSON field to store scores from word tests associated with this publication
ComprehensionTestScores: Array or JSON field to store test scores for this publication
WordTestScore: Integer (representing the number of correct answers in the word test)
InitialShouldRememberCount: Integer (number of “should-remember” words learned upon publication completion)
ThreeMonthRetentionCount: Integer (number of “should-remember” words retained after 3 months)
OneYearRetentionCount: Integer (number of “should-remember” words retained after 1 year)
InitialTestDate: Date (date of the initial test upon publication completion)
ReviewWordsList: JSON array of words marked for review
ShouldRememberRetentionRate: Float (retention rate for “should-remember” words)
ReviewWordRetentionRate: Float (retention rate for “review” words)
S4.6 WordPairs
PairID (Primary Key): Unique identifier for each word pair
TargetWord: □ “review” words, “should-remember” words, “read-and-go” words, and “learn-to-use” words from the publication
Equivalent: The known word or phrase to the user that is the equivalent in meaning in the context to the target word
Language: Language of the equivalents
UserID (Foreign Key to Users): Reference to the user for whom this word pair was created
S4.7 TargetWordFrequencies
FrequencyID (Primary Key): Unique identifier for each frequency entry
AdaptationID (Foreign Key to PublicationAdaptations): Reference to the adapted publication
TargetWord: The word whose frequency is being recorded
Frequency: Number of occurrences of the target word in the adapted publication
S4.8 ReviewWordSources
SourceID (Primary Key): Unique identifier for each review word source entry
UserID (Foreign Key to Users): Reference to the user
PublicationID (Foreign Key to PublicationLibrary): Reference to the publication selected as a source for review words
IsSelected (Boolean): Indicates whether this publication is currently selected as a review word source
LastUpdated (Timestamp): When this source was last updated or selected/deselected
S4.9 RelationalPublicationSets
SetID (Primary Key): Unique identifier for each relational publication set
Name: Name of the set
TargetProficiencyLevel: Intended proficiency level for the set
CreationDate: Date the set was created
LastUpdated: Date the set was last modified
IsIndividualSet (Boolean): Indicates if the set is for a specific individual or a general proficiency level
S4.10 RelationalPublicationSetItems
ItemID (Primary Key): Unique identifier for each item in a set
SetID (Foreign Key to RelationalPublicationSets): Reference to the set
PublicationID (Foreign Key to PublicationLibrary): Reference to the publication
OrderInSet: Integer indicating the order of the publication within the set
S4.11 ReadingGroups
GroupID (Primary Key): Unique identifier for each reading group
GroupName: Name of the reading group
CreationDate: Date the group was created
LastUpdated: Date the group was last modified
S4.12 GroupMembers
MembershipID (Primary Key): Unique identifier for each group membership
GroupID (Foreign Key to ReadingGroups): Reference to the reading group
UserID (Foreign Key to Users): Reference to the user
JoinDate: Date the user joined the group
S4.13 GroupPublications
GroupPublicationID (Primary Key): Unique identifier for each group publication
GroupID (Foreign Key to ReadingGroups): Reference to the reading group
PublicationID (Foreign Key to PublicationLibrary): Reference to the publication
AdaptationLevel: The adaptation level for this group publication
S4.14 GroupWordLists
ListID (Primary Key): Unique identifier for each group word list
GroupID (Foreign Key to ReadingGroups): Reference to the reading group
PublicationID (Foreign Key to PublicationLibrary): Reference to the publication
WordType: Type of word list (‘review’, ‘should-remember’, ‘read-and-go’, ‘learn-to-use’)
Words (Array or JSON field): List of words for this type and publication
S4.15 WordTestResults
TestResultID (Primary Key): Unique identifier for each test result
UserID (Foreign Key to Users): Reference to the user who took the test
PublicationID (Foreign Key to PublicationLibrary): Reference to the publication the test is based on
TestDate: Date and time the test was taken
WordsTested: List of words included in the test
UserResponses: User's answers for each word
CorrectAnswers: Correct answers for each word
Score: Overall test score
S4.16 ReadingComprehensionTests
TestID (Primary Key): Unique identifier for each test
UserID (Foreign Key to Users): Reference to the user taking the test
PublicationID (Foreign Key to PublicationLibrary): Reference to the publication
TestDate: Date and time the test was taken
RawScore: Number of correct answers (0-10)
LexileRating: Lexile rating of the publication
FinalScore: RawScore multiplied by LexileRating
UserAnswers: Array or JSON field storing user's selected answers
CorrectAnswers: Array or JSON field storing correct answers
ErrorAnalysis: JSON field storing AI-generated brief explanations for incorrect answers
S4.17 OralPresentations
PresentationID (Primary Key): Unique identifier for each presentation.
UserID (Foreign Key to Users): Reference to the user who made the presentation.
PublicationID (Foreign Key to PublicationLibrary): Reference to the publication related to the presentation.
PresentationDate: Date and time of the presentation.
VideoRecordingURL: Link to the recorded video of the presentation.
RawTranscript: Raw transcript generated from the presentation.
CorrectedTranscript: Edited version of the transcript with corrections made by AI.
Score: Numeric score reflecting user performance.
S4.18 WritingSubmissions
SubmissionID (Primary Key): Unique identifier for each writing submission
UserID (Foreign Key to Users): Reference to the user who submitted the article
ArticleContent: Original content of the submitted article
CorrectedContent: Edited version of the article with corrections made by AI
SubmissionDate: Date and time of submission
Score: Numeric score reflecting user performance
AggregateSetID: Identifier for the set of 10 articles this submission belongs to
AggregateScore: The aggregate score for the set of 10 articles (updated every 10 submissions)
S4.19 ProspectivePublications
ProspectiveID (Primary Key): Unique identifier for each prospective publication
PublicationID (Foreign Key to PublicationLibrary): Reference to the publication
UserID (Foreign Key to Users): Reference to the user who proposed the publication
DateAdded: Date when the publication was added as a prospective option
Status: Current status of the prospective publication (e.g., ‘Pending’, ‘Approved’, ‘Rejected’)
Explanation: This table stores information about publications that are being considered for inclusion in relational sets. It allows users or administrators to propose publications and tracks their status in the selection process.
S4.20 CouldBeNewWordsLists
ListID (Primary Key): Unique identifier for each list
PublicationID (Foreign Key to PublicationLibrary): Reference to the publication
Words: Text or JSON field storing the list of words and their frequencies
Explanation: This table stores the lists of potential new words for each publication, along with their frequencies. These lists are crucial for the analysis process to determine which publications should be grouped together in relational sets.
S4.21 PublicationClusters
ClusterID (Primary Key): Unique identifier for each cluster of publications
PublicationID (Foreign Key to PublicationLibrary): Reference to the publication in the cluster
CommonWords: Text or JSON field storing the list of common new words for this cluster
Explanation: This table stores the results of the clustering analysis, grouping publications that share similar new words. This information is used to create coherent relational publication sets.
S4.22 RetentionTestSchedule
ScheduleID (Primary Key): Unique identifier for each scheduled test
UserID (Foreign Key to Users): Reference to the user
PublicationID (Foreign Key to PublicationLibrary): Reference to the publication
TestType: Enum (‘3-month’, ‘1-year’)
ScheduledDate: Date when the test is due
Status: Enum (‘Scheduled’, ‘Completed’, ‘Missed’)
S5. Core Components and Interactions
S5.1 Text Analyzer
Caller: Publication Manager
Called: Text Analyzer
Purpose: Analyze input text to identify target words, categorize them, record them, and create a review word list.
Input:
Text content (full publication)
UserID (to access vocabulary and language preferences)
X (number of should remember words, user specified)
Y (number of read-and-go words=number of new words−X)
List of selected source publications for review words
R (Desired number of review words, user specified)
L (Desired number of learn-to-use words, user specified)
GroupID (if analyzing for a group)
Output:
Group A (“Should Remember” words): List of “Should Remember” words from the list of new words
Group B (“Read-and-Go” words): List of remaining new words
Group C (“learn-to-use” words): List of R number of user-selected “should remember” words and “read-and-go” words from previously read publications that also appear in the current publication
TargetWordContextList: A list of objects, each containing:
TargetWord: The identified new word
Context: The full paragraph containing the target word (only the first occurrence)
Frequency: The number of occurrences of the target word in the publication
Category: “Should Remember” words, “Read-and-Go” words, “review” words, and “learn-to-use” words
Context Extraction Process
For each identified target word:
Extract the full paragraph containing the target word.
If the target word appears multiple times in the text, only store the context from the first occurrence.
S5.2 Adaptation Generator
Caller: Publication Manager
Called: Adaptation Generator
Purpose: Generate and store adapted versions of publications by inserting target words with appropriate marks into the original text, based on user or group selection, and generate a word test for “should-remember” words.
Input:
PublicationID
UserID or GroupID
Original publication text
Analyzed text data from Text Analyzer
Word pair layout information from Word Pair Layout Generator
User or group preferences for word marking and layout
Process:
Retrieve the original publication text
Apply Word Pair Layout Logic to determine positioning of equivalents relative to target words
Apply Word Pair Marking Logic to visually designate words based on preferences
Insert target words and their equivalents at designated locations in the text, applying determined positioning, formatting, and marking methods
Generate the adapted text with inserted target words and appropriate marks
Call Word Test Generator (S5.12) to create a test for all “should-remember” words in the publication
Output:
AdaptedPublications: The modified text with inserted target words and appropriate marks
WordTest: Generated test for “should-remember” words
Post-processing:
Store the generated adapted publication in the PublicationAdaptations table
Store the generated word test along with the adapted publication
S5.3 Publication Manager
Caller: User Interface
Called: Publication Manager
Purpose: Manage the preparation and delivery of publications to users, including the integration of various word lists for learning purposes.
Input:
UserID
PublicationID
User's reading level and preferences
User's VocabularyStocks
User's ReviewWordsList
Output:
Adapted publication with integrated word lists (“should-remember,” “read-and-go,” “review”)
Updated UserReadingProgress
Supplementary learning materials
S5.4 Reading Interface
Caller: User Interface
Called: Reading Interface
Purpose: Provide an interactive reading experience for users, allowing them to engage with the text and interact with words.
Input:
UserID
PublicationID
Adapted text content
Process:
Display the adapted text content to the user
Allow users to click on words to see definitions or translations
Enable text selection for copying or looking up phrases
Provide navigation controls (e.g., next page, previous page, bookmarking)
Allow users to add annotations or notes to the text
Track user's reading progress and update UserReadingProgress
Detect double-clicks on “read-and-go” words
S5.5 Word Pair Generator
Caller: Text Analyzer
Called: Word Pair Generator
Purpose: Generate suitable equivalents for target words to form word pairs.
Input:
Target words list
Context for each target word (from TargetWordContextList)
UserID (to access language preferences and vocabulary level)
Text language
GroupID (if generating for a group)
Output: List of word pairs (target words and equivalents)
AI Integration: The system will call an AI service to generate suitable equivalents for target words based on their context and usage: if the text is in the user's first language, the equivalents and the target words will all be in the user's first language, but the equivalents are known to the user, and the target words are not known to the user; if the text is in the user's second language, the equivalent will be in the user's first language.
S5.6 Word Pair Layout Generator
Caller: Adaptation Generator
Called: Word Pair Layout Generator
Purpose: Categorize locations of target words and determine word pair placement based on user preference and target word frequency.
Input:
Text content with identified target words
Word pair list
Target word frequencies
UserID (to access WordPairOccurrencePattern and EquivlentInWordPairPositionPreference)
GroupID (if generating for a group)
Output: Categorized list of word locations (word pair locations and non-word pair locations)
S5.7 Relational Publication Set Manager
Caller: Publication Manager or User Interface
Called: Relational Publication Set Manager, Could-Be-New-Words Analyzer
Purpose: Create and manage relational publication sets for long-term learning, incorporating analysis of new word concentration in subsequent publications.
Input:
List of prospective PublicationIDs (manually provided)
GroupID (if managing for a group)
H value (number of high-frequency new words to consider, user-specified)
Process:
Receive the list of prospective publications (manually provided).
Call Could-Be-New-Words Analyzer to analyze publications and perform cluster analysis using AI.
Select publications from the cluster that has the most common Could-Be-New-Words.
Create and store the relational publication set.
Output:
Relational publication set ID
List of selected publications in the set
Cluster analysis results (for potential review by administrators)
S5.8 Interactive Reader Component
Caller: User Interface
Called: Interactive Reader Component
Purpose: Provide an interactive reading experience with word highlighting, clickable elements, and context-sensitive actions
Input: AdaptedContent, UserID, PublicationID, GroupID (if reading in group mode)
Output: Interactive reading interface with user interactions
S5.9 Group Manager
Caller: User Interface
Called: Group Manager
Purpose: Handle creation, modification, and deletion of reading groups, manage group memberships, assign publications to groups, and set group adaptation levels.
Input: GroupID, UserID, Action (create, modify, delete, join, leave), PublicationID (for assigning publications)
Output: Confirmation of action, Updated group information
S5.10 Group Reading Progress Tracker
Caller: Reading Interface
Called: Group Reading Progress Tracker
Purpose: Track reading progress for each user within a group context, aggregate group-level statistics and individual progress within the group.
Input: GroupID, UserID, PublicationID, ReadingProgress
Output: Updated group and individual progress statistics
S5.11 Could-Be-New-Words Analyzer
Caller: Relational Publication Set Manager
Called: Could-Be-New-Words Analyzer
Purpose: Analyze prospective publications to create Could-Be-New-Words lists and perform cluster analysis on publications.
Input:
List of prospective PublicationIDs
H value (number of high-frequency new words to consider, user-specified)
Output:
Could-Be-New-Words lists for each publication
Clusters of publications with common Could-Be-New-Words
Process:
Extract new words and their frequencies from each prospective publication.
Create Could-Be-New-Words lists for each publication using the top H frequent new words.
Perform AI-powered cluster analysis on the publications based on their Could-Be-New-Words lists.
Identify clusters of publications that share the most common new words.
Return the Could-Be-New-Words lists and publication cluster results.
AI Integration: Utilize AI services for cluster analysis to group publications with similar new word profiles.
Explanation: This component is responsible for analyzing the vocabulary content of prospective publications and identifying commonalities between them. It uses AI-powered clustering to group similar publications based on their new word content, which is crucial for creating effective relational publication sets.
S5.12 Word Test Generator
Caller: Text Analyzer
Called: Word Test Generator
Purpose: Generate a test for each word listed as “should remember.”
Input:
List of “should remember” words from Group A (“Should Remember” words)
Context for each word (from TargetWordContextList)
Output:
List of word tests, each containing:
Sentence: A sentence where the word appears, with the word highlighted.
Choices: Three options for users to select from, with only one correct equivalent.
AI Integration: The system will call an AI service to generate the sentences and multiple-choice options for each “should remember” word. The AI will utilize the context provided to ensure relevance and accuracy in the generated tests.
S5.13 Word Test Manager
Caller: User Interface
Called: Word Test Manager
Purpose: Manage the administration of word tests, record results, and provide feedback to users.
Input:
UserID
PublicationID
List of word tests generated by the Word Test Generator
User's test responses
Process:
Present the word test to the user through an interactive interface
Collect and record user's responses for each test question
Score the test by comparing user responses to correct answers
Calculate the WordTestScore by counting the number of correct answers
Update UserReadingProgress. WordTestScore with the calculated score
Generate feedback for each question (correct/incorrect)
Identify all correctly answered “should-remember” words
Call Vocabulary Stocks Updater (S5.25) with:
   UserID
   List of correctly answered “should-remember” words
   PublicationID
Store test results in the database
If the test is a retention test (3-month or 1-year):
Retrieve the original “should-remember” words for the publication
Generate a test for these words
After scoring, update the appropriate retention count in UserReadingProgress
Update the RetentionTestSchedule status to ‘Completed’
Include “review” words in the 3-month retention test along with “should-remember” words
After scoring, update the retention status for both “should-remember” and “review” words
If a “review” word is retained, call Vocabulary Stocks Updater to add it to VocabularyStocks
Output:
Interactive word test interface
Test results (including score and feedback for each question)
Updated user progress in UserReadingProgress table
Confirmation of VocabularyStocks update
S5.14 Reading Comprehension Test Generator
Caller: Publication Manager
Called: Reading Comprehension Test Generator
Purpose: Generate a reading comprehension test based on new words and associated paragraphs from a publication.
Input:
PublicationID
List of new words with associated paragraphs
Lexile rating of the publication
Output:
10 multiple-choice test items, each with a sentence and 3 answer choices
AI Integration: Utilizes AI to analyze paragraphs, generate relevant questions, and create plausible answer choices.
S5.15 Reading Comprehension Test Analyzer
Caller: Reading Interface
Called: Reading Comprehension Test Analyzer
Purpose: Analyze user's test responses and generate feedback
Input:
UserID
TestID
User's answers
Correct answers
Lexile score of the publication
Output:
Raw score
Final score (raw score multiplied by Lexile score)
List of correct and incorrect answers
Brief analysis for each incorrect answer
AI Integration: Employs AI to generate personalized explanations for incorrect answers, identifying potential misunderstandings or misconceptions.
S5.16 Oral Presentation Interface
Caller: User Interface
Called: Oral Presentation Interface
Purpose: Facilitate users in conducting oral presentations based on their reading.
Input:
UserID
PublicationID
Output:
Video recording of the oral presentation.
S5.17 Transcript Generator
Caller: Oral Presentation Interface
Called: Transcript Generator
Purpose: Create a transcript from the recorded oral presentation.
Input:
Video recording of the presentation.
Output:
Raw transcript of the presentation.
S5.18 AI Transcript Correction Integration
Caller: Transcript Generator
Called: AI Correction Module
Purpose: Integrate AI to make necessary corrections to the transcript.
Input:
Raw transcript generated from the presentation.
Output:
Corrected transcript presented to the user without explanations.
S5.19 Oral Presentation Scoring System
Caller: Oral Presentation Interface
Called: Oral Presentation Scoring System
Purpose: Grade the user's presentation and provide a score to rate progress.
Input:
UserID
PublicationID
Raw transcript
Corrected transcript
Output:
Score reflecting user performance based on comparative analysis with previous presentations.
Grading Methodology:
The first presentation receives a score of 100.
Each subsequent presentation (2nd to 20th) is scored based on a comparison with all previous presentations, specifically:
For presentations 2 to 10, each score is calculated based on comparisons with the first presentation.
For the 11th presentation, it is compared with the average score of the first ten presentations, and this process continues for each subsequent presentation.
Aggregate average score for every ten presentations is calculated by comparing with the earlier ten presentation so that an average score of ten presentation can compare with the earlier average score of ten presentation to see the progress.
S5.20 Oral Presentation Data Storage
Caller: Oral Presentation Interface
Called: Data Storage Module
Purpose: Store all relevant data related to oral presentations.
Input:
Video recording URL
Raw transcript
Corrected transcript
Score for each presentation
Output:
All data is stored in the OralPresentations table for future reference.
S5.21 Writing Submission Interface
Caller: User Interface
Called: Writing Submission Interface
Purpose: Allow users to upload a short article based on their reading.
Input:
UserID
File containing the article (e.g., .docx, .txt)
Output:
Confirmation of successful upload
S5.22 AI Writing Correction Integration
Caller: Writing Submission Interface
Called: AI Writing Correction Module
Purpose: Integrate AI to make necessary corrections to the uploaded article.
Input:
Uploaded article
Output:
Corrected article with brief explanations for errors
S5.23 AI Writing Evaluation System
Caller: Writing Submission Interface
Called: AI Grading Module
Purpose: Grade the user's article and provide a score to rate progress.
Input:
UserID
Article content
Previous articles (for comparison)
Output:
Score reflecting user performance based on comparative analysis
AI Grading Instructions:
For the first article submitted by a user, assign a score of 100.
For articles 2 through 10:
Compare each new article with the first article.
Assign a score based on improvements or declines in writing quality, coherence, and adherence to the topic.
Store individual scores for each article.
After the 10th article:
Calculate an aggregate score of 100 for these first 10 articles, considering their individual scores.
For the 11th article and beyond:
Compare the new article with the previous 10 articles.
Assign a score relative to the aggregate score of the previous 10 articles.
This score can be higher or lower than 100, reflecting improvement or decline.
After every 10 articles:
Calculate a new aggregate score for that set of 10 articles.
This aggregate score can be higher or lower than 100, reflecting overall progress.
Continue this pattern indefinitely, always comparing new articles to the previous set of 10 and calculating new aggregate scores for each set of 10.
In your evaluation, consider factors such as:
Grammar and syntax
Vocabulary usage and diversity
Coherence and structure
Relevance to the reading material
Depth of analysis or creativity
8. Provide a brief explanation for the score, highlighting areas of improvement or aspects needing attention.
S5.24 Writing Data Storage
Caller: Writing Submission Interface
Called: Data Storage Module
Purpose: Store all relevant data related to writing submissions.
Input:
Original article
Corrected article
Score for each submission
Aggregate scores for each set of 10 articles
Output:
Confirmation of data storage
S5.25 Vocabulary Stocks Updater
Caller: Word Test Manager
Called: Vocabulary Stocks Updater
Purpose: Update user's VocabularyStocks with correctly answered words from word tests, including both “should-remember” and “review” words.
Input:
UserID (Foreign Key to Users): Reference to the user
Correctly AnsweredWords (Array): List of words correctly answered in the word test
WordOrigin (Enum): Indicates whether the word is “should-remember” or “review”
PublicationID (Foreign Key to PublicationLibrary): Reference to the publication associated with the test
Process:
Retrieve user's current VocabularyStocks from Users table
For each word in Correctly AnsweredWords:
   2.1. Check if the word is not already in Vocabulary Stocks
   2.2. If not present:
   a. Add the word to VocabularyStocks
   b. Record the word's origin (“should-remember” or “review”)
   c. Record the PublicationID where the word was encountered
   d. Record the date the word was added
   2.3. If already present:
   a. Update the last encountered date
   b. Increment a counter for number of times correctly answered
Update the total word count in VocabularyStocks
Calculate and update retention rates for “should-remember” and “review” words separately
Update the Users table with the modified VocabularyStocks
If the word was from the ReviewWordsList:
   6.1. Remove the word from the user's ReviewWordsList
Create an entry in a WordLearningHistory table to track the word's learning progress
Output:
Updated VocabularyStocks in the Users table
Updated retention rates for “should-remember” and “review” words
Updated ReviewWordsList (if applicable)
New entry in WordLearningHistory table
Confirmation of successful update
S5.26 Retention Test Scheduler
Caller: Word Test Manager
Called: Retention Test Scheduler
Purpose: Schedule and manage retention tests for “should-remember” words at 3-month and 1-year intervals.
Input:
UserID
List of “should-remember” words with their introduction dates
Process:
3-Month Test Scheduling:
Schedule a single 3-month test to occur every three calendar months (e.g., March, June, September, December).
For each 3-month test, include all “should-remember” words that the user has encountered since the last 3-month test before the last, up until three months ago.
Annual Test Scheduling:
Schedule monthly annual tests for each user.
For each monthly annual test, include all “should-remember” words that were introduced between 12 and 13 months ago.
Test Composition:
Ensure all eligible “should-remember” words are included based on their respective inclusion criteria for 3-month and annual tests.
Randomize the order of words for each test.
User Notification:
Generate notifications for upcoming tests.
Send reminders to users before scheduled test dates.
Flexibility Window:
Set a time window (e.g., one month for annual tests, one week for 3-month tests) around the scheduled date for users to complete each test.
Word Tracking:
Continuously update and track the introduction date of each “should-remember” word.
Use this data to determine eligibility for each test.
Store scheduled test information in the RetentionTestSchedule table.
Output:
Confirmation of scheduled retention tests
List of words included in each scheduled test
Notification and reminder schedules for users
Additional Features:
Generate a cumulative annual report at the end of each calendar year, aggregating data from all monthly annual tests conducted that year.
This report includes:
a. Total words tested across all monthly annual tests
b. Total words retained
c. Overall annual retention rate
S5.27 Vocabulary Development Analyzer
Caller: User Interface
Called: Vocabulary Development Analyzer
Purpose: Analyze and report on vocabulary development over time. Input:
UserID
PublicationID (optional, for specific publication analysis)
Process:
Retrieve initial, 3-month, and 1-year retention counts from UserReadingProgress
Calculate retention rates at 3 months and 1 year
Generate a report on vocabulary development
Output:
Vocabulary development report including initial learning, 3-month retention, and 1-year retention statistics
S5.28 Word Status Updater
Caller: Reading Interface
Called: Word Status Updater
Purpose: Update the status of “read-and-go” words to “review” when double-clicked by the user.
Input:
UserID
PublicationID
Word
CurrentStatus (“read-and-go”)
NewStatus (“review”)
Process:
Update the word's status in the UserReadingProgress table
Add the word to the ReviewWordsList for the user's next publication
Output:
Confirmation of status update
S5.29 Word Retention Analyzer
Caller: User Interface
Called: Word Retention Analyzer
Purpose: Analyze and report on word retention performance for both “should-remember” and “review” words.
Input:
UserID
TimeFrame (optional, for specific time period analysis)
Process:
Retrieve retention data for “should-remember” and “review” words
Calculate retention rates for each category
Generate separate measures for “should-remember” and “review” word development
Output:
Word retention performance report
Separate measures for “should-remember” and “review” word development
Personalized advice for improving retention in each category
S6. AI Integration
The system utilizes advanced features from various AI services, which may include but are not limited to:
OpenAI's GPT models,
Meta's Llama models,
Google's PaLM, and other state-of-the-art language models,
And possibility some other Ais
These AI services provide:
1. Natural Language Processing capabilities such as word identification and categorization.
2. Multilingual Support enhancing language capabilities across multiple languages.
3. Extended Context Length allowing processing longer texts.
4. Semantic Understanding identifying simpler synonyms or translations.
The system should be designed with flexibility to switch between different AI services based on performance, cost, or specific language requirements.
S7. User Interface
The web-based UI includes:
S7.1. Interactive Reader Interface:
Text Display with customizable font sizes, styles, color schemes.
Word Highlighting with automatic highlighting of target words and phrases.
Clickable Words that trigger actions when clicked.
Text Selection allowing users to select text for functions like defining terms.
Context Menu appearing on selection with options like “Define,” “Add to Review List,” “Hear Pronunciation.”
Navigation Controls including progress indicators and bookmarking features.
Annotation Tools allowing highlighting and note-taking features.
S7.2. Text input area for uploading or pasting content.
S7.3. Adapted text display with visual enhancements and word pairs.
S7.4. User profile management interface.
S7.5. Publication selection interface with options for personal or leveled adaptations.
S7.6. Review word list display for reinforcement.
S7.7. Toggle option for displaying word pairs in adapted text.
S7.8. Word Pair Occurrence Pattern: A dropdown/input field where users can specify how often they want word pairs to appear.
S7.9. EquivlentInWordPairPositionPreference: Options for users to set their preferred positioning (‘after’, ‘before’, ‘above’, ‘below’, ‘in parentheses’, ‘auto’).
S7.10. Word Pair Formatting: Options for users to customize appearance (font style, size, color).
S7.11. Review Word Source Selection Interface: Users select previously read books as sources.
S7.12. Review Word Count Setting: Allow users to set desired number of review words.
S7.13. Export/Download Option: Feature allowing users to save adapted publication in printable format (PDF, DOCX).
S7.14. Relational Publication Set creation/management interface.
S7.15. Long-term learning progress tracking across multiple publications.
S7.16. Toggle between single publication mode, relational publication set mode, and group reading mode.
S7.17. Group creation and management interface.
S7.18. Group reading mode selection and interface.
S7.19. Reading Program Manager Interface:
Dashboard with system-wide analytics and performance metrics.
User management tools including create, edit, delete user accounts.
Publication management tools including add, edit, remove publications from library.
Adaptation level management tools including create/modify adaptation levels.
Relational publication set management tools including create/edit sets.
System configuration settings adjustments.
Report generation tools for analytics on user progress.
Group management tools for creating, modifying, and monitoring reading groups.
S7.20 Word Test Interface
Interactive interface for users to take word tests.
Display each word test question with multiple-choice options.
Allow users to select their answers.
Show immediate feedback after each question or at the end of the test.
Display overall test results upon completion.
S7.21 Word Test Results Review Interface
Display overall test score and performance metrics.
Show a list of tested words with correct/incorrect indicators.
Provide options to review incorrect answers and see correct definitions.
S7.22 Reading Comprehension Test Interface
Display 10 multiple-choice questions
Allow users to select one answer for each question
Submit answers and view results
After test submission, provide option to view detailed results
S7.23 Reading Comprehension Test Results Review Interface
Display raw score and final score
Show correct answers for all questions
For incorrect answers, display:
User's selected answer
Correct answer
Brief analysis explaining the error (AI-generated)
S8. Application Logic
The core algorithm steps:
S8.1. Determine if the user is working with a single publication, relational publication set, or in group reading mode.
S8.2. If single publication:
S8.2.1 Receive input text and user data.
S8.2.2 Use Text Analyzer to analyze and categorize into “should remember,” “read-and-go,” and valuable phrases.
S8.2.3 Use Word Frequency Calculator to determine frequency of each target word.
S8.2.4 Record categorized words in UserReadingProgress.
S8.2.5 Store target frequencies in TargetWordFrequencies table.
S8.2.6 Create new list of review words:
S8.2.6.1 Retrieve user's selected source publications for review words.
S8.2.6.2 Retrieve “should remember” words from these selected publications.
S8.2.6.3 Filter this to include only words present in the current publication.
S8.2.6.4 If the number of filtered words is greater than the user's desired count (R): Randomly select R words from the filtered list.
S8.2.6.5 If fewer than R: Use all filtered words.
S8.2.6.6. Return this list as the Review Words List.
S8.2.7 Determine if the text is in the reader's first or second language.
S8.2.8 Generate word pairs based on language context.
S8.2.9 Use Word Pair Layout Generator to categorize target word locations based on frequencies and user preference:
S8.2.9.1 For each occurrence, assign an order index and position in the text,
S8.2.9.2 Designate occurrences as pair or non-pair based on user's preference.
S8.2.10 Apply Word Pair Layout Logic to determine positioning of equivalents relative to target words.
S8.2.11 Apply Word Pair Marking Logic to visually designate using various methods based on preferences and cognitive considerations.
S8.2.12 Apply Target Word Marking Logic to distinctly mark at non-word pair locations using appropriate methods and established patterns/habits.
S8.2.13 Layout the text with a perceptible network of relational targets while maintaining readability.
S8.2.14 Replace target words at designated pair locations with corresponding pairs, applying determined positioning, formatting, and marking methods.
S8.2.15 Generate adapted text in printable format (PDF/DOCX).
S8.2.16 Save adapted file and make available for download/print.
S8.2.17 Present adapted text along with review lists and word pairs in the web interface.
S8.3 If relational publication set:
S8.3.1 If creating a new set:
S8.3.1.1 Use Relational Set Manager to select and sequence publications:
S8.3.1.1.1 Select for gradual increase in vocabulary difficulty and comprehension level,
S8.3.1.1.2 Prioritize higher concentrations of “should remember” words from earlier publications.
S8.3.1.2 Compile selected publications into a relational set.
S8.3.2 For each publication in the set:
[Repeat steps S8.2.1 to S8.2.17 from single publication process]
S8.3.3 After processing all publications:
S8.3.3.1 Analyze relations across the entire set,
S8.3.3.2 Identify networks of relational targets within each publication,
S8.3.3.3 Simultaneously determine and adjust relational targets considering cross-publication relationships,
S8.3.3.4 Reapply adaptation method if necessary:
S8.3.3.4.1 For a specific reader, tailor the layout to individual progress and needs,
S8.3.3.4.2 For readers at a certain proficiency level, design to accommodate average needs and expected progress.
S8.4 If in group reading mode:
S8.4.1 Retrieve group information and member data.
S8.4.2 For each publication assigned to the group:
[Repeat steps S8.2.1 to S8.2.17 from single publication process]
S8.4.3 After processing all group publications:
S8.4.3.1 Analyze relations across all group publications.
S8.4.3.2 Identify networks of relational targets within each publication for the group.
S8.4.3.3 Simultaneously determine and adjust relational targets considering cross-publication relationships and group dynamics.
S8.4.3.4 Reapply adaptation method if necessary:
S8.4.3.4.1 For the entire group, tailor the layout to accommodate average group proficiency level and needs.
S8.4.3.4.2 For individual group members, provide personalized annotations or supplementary materials as needed.
S8.4.4 Generate group-specific word lists and review materials.
S8.4.5 Present adapted content to all group members simultaneously.
S8.4.6 Track individual and aggregate group progress in GroupReadingProgress table.
S8.4.7 Facilitate group discussions and collaborative learning activities through integrated communication tools.
S8.5 After completion of a publication:
S8.5.1 Generate reading comprehension test using AI-powered Reading Comprehension Test Generator
S8.5.2 Present test to user through Reading Comprehension Test Interface
S8.5.3 Calculate raw score and final score
S8.5.4 Store test results in ReadingComprehensionTests table
S8.5.5 Update ComprehensionTestScores in UserReadingProgress table
S8.5.6 Call AI-powered Reading Comprehension Test Analyzer to process results and generate feedback
S8.5.7 Store detailed results and AI-generated analysis in ReadingComprehensionTests table
S8.5.8 Present option to user to view detailed results through Test Results Review Interface
S8.5.9 Calculate WordTestScore by counting the number of correct answers
S8.5.10 Update UserReadingProgress. WordTestScore with the calculated score
S8.6 After a user completes an oral presentation:
S8.6.1 Open the Oral Presentation Interface to record the presentation.
S8.6.2 Upon completion, generate a raw transcript using the Transcript Generator.
S8.6.3 Use AI Correction Integration to present both raw and corrected transcripts without explanations.
S8.6.4 Utilize the Oral Presentation Scoring System to evaluate performance and assign a score based on comparisons with previous presentations, following the specified grading methodology.
S8.6.5 Store all relevant data (video recording, transcripts, score) in the OralPresentations table.
S8.7 After a user uploads a writing article:
S8.7.1 Open the Writing Submission Interface to allow file upload.
S8.7.2 Upon successful upload, use the AI Correction Integration to generate a corrected article with brief explanations of errors.
S8.7.3 Present both original and corrected articles to the user along with explanations.
S8.7.4 Utilize the AI Writing Evaluation System to grade the article based on the provided instructions.
S8.7.5 Store all relevant data (original article, corrected article, individual score, and aggregate score if applicable) in the WritingSubmissions table.
S9. Data Flow
S9.1. User selects a publication or relational set to read.
S9.2. System retrieves content and user data.
S9.3. Text Analyzer processes to identify target words.
S9.4. Categorizes into “should remember,” “read-and-go,” and “learn-to-use”.
S9.5. Word Frequency Calculator determines frequency of target words.
S9.6. System retrieves user's selected source publications.
S9.7. System retrieves “should remember” words from selected publications.
S9.8. The system filters words that are present in the current publication and selects up to R review words based on user-defined preferences
S9.9. Word Pair Generator creates suitable equivalents using AI
S9.10. Word Pair Layout Generator categorizes locations based on frequencies and preferences.
S9.11. Word Pair Layout Generator applies marking logic according to the user or group reading manager's choices.
S9.12. System replaces target words with corresponding pairs at designated locations, applying determined positioning, formatting, and marking methods as specified by preferences.
S9.13. System generates adapted text in printable format (PDF/DOCX).
S9.14. System saves file(s), makes available for download.
S9.15. Adapted content along with marked networks is displayed in web interface and available for download.
S9.16. Interactive Reader Component processes user interactions with text.
S9.17. System updates user progress/annotations based on interactions.
S10. Security and Privacy
Implement secure API calls to AI services
Encrypt sensitive data in the database
Ensure GDPR compliance in data handling
Implement strong authentication and authorization
Use HTTPS for all data transmissions
Regularly update and patch all system components
S11. Scalability and Performance
Utilize cloud provider's high-speed inference capabilities
Implement database indexing for efficient queries
Use caching mechanisms for frequently accessed adaptations
Implement load balancing and distributed processing for adaptations
Optimize queries for handling large relational sets
Use asynchronous processing for long-running tasks like analysis
S12. Future Enhancements
Integrate more advanced models as they become available
Develop a mobile application version, browser extensions, etc.
Introduce collaborative features for shared reading experiences
Develop an API for third-party integration with other learning platforms
S13. Word Pair Generation, Layout, and Marking Logic
S13.1 Word Pair Generation For text in the reader's first language:
S13.1.1 Both equivalent & target are in the same language
S13.1.2 Equivalent is simpler or known
S13.1.3 Target words are unknown or more complex
S13.1.4 Integrating an AI to perform finding appropriate equivalents for target words
S13.2 For second language text:
S13.2.1 Equivalent is in the first language
S13.2.2 Identify target words based on user's second language vocabulary level and text difficulty, target words remain in the second language as they appear in the text
S13.2.3 Integrating an AI to perform finding appropriate equivalents for target words
S13.3 Word Pair Layout Logic
S13.3.1 Determine the frequency and importance of each target word
S13.3.2 Calculate the optimal distribution of word pairs based on user's WordPairOccurrencePattern
S13.3.3 For each target word occurrence, decide whether it should be paired based on the calculated distribution
S13.3.4 For paired occurrences, determine the position of the equivalent based on user's EquivalentIn WordPairPositionPreference
S13.3.5 If ‘auto’ is selected, use an algorithm to determine the best position based on surrounding text and layout
S13.3.6 Ensure that the layout maintains readability and doesn't overload the user cognitively
S13.4 Word Pair Marking Logic
S13.4.1 Retrieve user's WordPairFormattingPreference and MarkingStylePreference
S13.4.2 Apply the specified formatting to word pairs and target words:
For word pair locations:
Format both the target word and its equivalent according to user preferences
   Apply marking methods including, but not limited to: Color highlighting
      Underlining
      Bold or italic formatting
      Font size or type changes
      Leaving words unmarked as appropriate
   b) For non-word pair locations (target words only):
   Apply marking methods as listed above, potentially using different styles to distinguish from word pairs
S13.4.3 Implement adaptive marking logic that considers:
a) The reader's established word recognition patterns
b) The reader's new word memorizing habits
c) The reader's incidental learning capacity for new words
d) The frequency and recency of word exposure within the text
e) The cognitive load associated with different marking methods
S13.4.4 Apply different marks to the same word in different positions based on:
a) The word's role (target word in a pair, standalone target word, or equivalent)
b) The word's position in the text (first occurrence, subsequent occurrences)
c) The surrounding context and layout considerations
S13.4.5 Ensure the layout maintains readability, facilitates learning, and preserves aesthetic appeal:
a) Balance the visibility of marked words with overall text readability
b) Adjust marking intensity or method based on the density of target words in a given section
c) Consider the visual flow of the text when applying marks
d) Maintain consistency in marking style throughout the document while allowing for adaptive changes based on the factors in $13.4.3
S13.4.6 Implement a feedback mechanism to track the effectiveness of different marking styles for individual users, allowing for personalized optimization over time.
S13.5 Target Word Marking Logic
S13.5.1 For unpaired target word occurrences, apply a distinct marking style based on MarkingStylePreference
S13.5.2 Ensure consistency in marking style throughout the text to establish a clear pattern for the reader
S13.6 Identify Publications with High Concentration of New Words
S13.6.1 Identify relationship target words among a group of publications with high concentration of new words to specific user or users in a group reading mode
S13.7 Review Words Selection
S13.7.1 Retrieve user's selected source publications for review words
S13.7.2 Extract “should-remember” words from these publications
S13.7.3 Compare with current publication's text
S13.7.4 Select words that appear in both the current publication's text and in the “should-remember” words of the user's selected source publications for review words
S13.7.5 If selected words exceed user's DesiredReviewWordCount (R):
S13.7.5.1 Prioritize words based on frequency and recency
S13.7.5.2 Randomly select from prioritized list to reach R words
S13.7.6 If selected words are fewer than R:
S13.7.6.1 Just take the selected words to form the review word list
S13.7.7 Mark selected review words in the text
S13.7.8 Generate a separate review word list for user reference
S13.7.9 Update UserReadingProgress with selected review words
S13.8 Finding Relational Publication Set Analysis for Concentration of New Words in Subsequent Publications
S13.8.1 First, get all the new words from each of the prospective relational publications, get their frequencies in each publications. Then, extract H number (users may specify, maybe 300 something) of new words that have highest frequencies in each book to form Could-Be-New-Words list, and get all such lists independently from all the prospective relational publications.
S13.8.2 Using AI to run cluster analysis of all such lists of Could-Be-New-Words from all the prospective relational publications and find clusters that have more common Could-Be-New-Words.
S13.8.3 Picking up a sub-set of the prospective relational publications that are in clusters with most common Could-Be-New-Words, and these are the relational publication set that we would have found.
S14. User Preferences
Set first and second languages
Toggle display of adapted texts
Word pair occurrence pattern: choose how often they appear (e.g., every occurrence)
Equivalent positioning preference (e.g., after, before, above, below, in parentheses, auto)
Formatting preference (font style, size, color)
Selected sources for review words
Desired number of review words
Preferred learning pace
Long-term learning goals
Default mode (single/relational)
Marking style preferences
Cognitive load tolerance setting (low, medium, high)
S15. System Modes
S15.1 Single Publication Mode
Functions exactly as described in the original specification, processing one publication at a time and using individual reading history.
S15.2 Relational Publication Set Mode
Creates and manages sets for long-term learning, processes multiple publications with consideration of inter-publication relationships, optimizes learning across the entire set while maintaining readability of individual publications. Can be tailored for individual users or general proficiency levels.
S15.3 Group Reading Mode
Allows users at the same reading level and with the approximately the same amount of vocabulary words to collaboratively engage with the same readings.

### Word-Pair Facilitated Reading-Based-Learning Strategy Analysis and Recommendation Tool Powered by AI-Sub-System For the Word-Pair Facilitated Reading-Based-Learning System Powered by AI (the Basic System)

The Reading-Based Learning System Powered by AI (the Basic System), specified in the earlier section as a basic system, is already a complete system that can facilitate reading-based learning using word pairs. AI is capable of detecting learning strategy and achievement patterns, which makes it perfect to add this tool as a sub-system to the Basic System.

### User Characteristics Analysis

This function collects and analyzes user data such as age, parent support, learning eagerness, and reading interests. It uses AI-driven clustering to group users with similar characteristics, enabling personalized learning strategies.

### The Goal-Oriented Learning Planner

Users can input specific language learning objectives, and the system will generate a detailed, personalized learning plan with weekly schedules and yearly milestones.

### Efficient Vocabulary Acquisition Analysis

This function calculates the most effective pace for vocabulary acquisition, considering the balance between learning new words and retaining previously learned ones. It recommends optimal weekly study hours to reach vocabulary goals.

By analyzing word retention rates and learning speeds across the user base, this function identifies the most efficient learning patterns. It provides tailored recommendations to improve individual learning efficiency.

Through continuous analysis of word retention rates and learning speeds across the user base, it determines the optimal pace for each learner. This prevents users from reaching a “breakeven point” where they forget words faster than they learn new ones, ensuring consistent progress.

### Learning Achievement Prediction

This function forecasts a user's future achievements in reading volume, vocabulary growth, and comprehension scores for 1, 2, and 3+ years ahead. It helps set realistic goals and tailor learning paths.

### Longitudinal Predictor Research

The sub-system also runs a study over the time to see what could be the best predictors to predict a user's progress in the reading-based-learning program. The sub-system continuously refines our understanding of what makes a successful reading-based learner. By identifying key predictors of long-term success, the system can adapt its recommendations over time.

### Adaptive Strategy Recommendation

This function combines insights from characteristic clusters and strategy clusters to suggest the most effective learning strategies for each user, adapting recommendations as the user progresses.

The following is the detailed sub-system specifications:

Note: the item numbering system matches the basic system in Section V so that all the items in the sub-system specifications can be inserted into the basic system in the numbering order.
S4. Database Design (New Additions)
S4.23 UserCharacteristics
Purpose: Stores data for modeling a user's characteristics.
Fields:
UserID (Primary Key, Foreign Key to Users)
Age: Integer representing the user's age.
ParentSupportDegree: Integer (1-5 scale) representing the degree of parent support and participation.
LanguageAcquisitionEagerness: Integer (1-5 scale) representing eagerness to acquire the language.
FirmLanguageGoals: Boolean indicating if the user has firm goals in acquiring the language.
ReadingInterestLevel: Integer (1-5 scale) representing the level of interest in reading.
SchoolStressDegree: Integer (1-5 scale) representing stress from schooling and extracurricular demands.
ReadingSubjects: Text field storing subjects of interest in reading (comma-separated).
LeisureReading: Boolean indicating if reading is used to absorb leisure time.
S4.24 LongitudinalPredictorResearch
Purpose: Stores results of long-term predictor analyses.
Fields:
ResearchID (Primary Key)
ResearchDate: Timestamp indicating when the research was conducted.
DataRangeStart: Date marking the start of data collection.
DataRangeEnd: Date marking the end of data collection.
SampleSize: Integer representing the number of users included in the analysis.
PredictorRankings: JSON storing ranked list of predictors and their importance scores.
StatisticalSignificance: JSON storing statistical significance for each predictor.
MethodologyNotes: Text providing details on the research methodology used.
ResearchFindings: Text summarizing key findings from the research.
RecommendedSystemUpdates: Text suggesting updates based on research findings.
S4.25 UserAchievementPredictions
Purpose: Records predicted achievements for each user at various future time points.
Fields:
PredictionID (Primary Key)
UserID (Foreign Key to Users)
PredictionDate: Timestamp indicating when predictions were made.
One YearPrediction: JSON storing predictions for achievements in one year.
TwoYearPrediction: JSON storing predictions for achievements in two years.
Three YearPrediction: JSON storing predictions for achievements in three years.
LongTermPrediction: JSON for predictions beyond three years.
ConfidenceIntervals: JSON storing confidence intervals for each prediction.
InfluencingFactors: Text detailing factors that influence predictions.
S4.26 UserGoalPlans
Purpose: Stores personalized learning plans for users to achieve their specified goals.
Fields:
PlanID (Primary Key)
UserID (Foreign Key to Users)
CreationDate: Timestamp indicating when the plan was created.
GoalDescription: Text describing the user's learning goal(s).
Timeframe Years: Integer indicating how many years the user has set to achieve their goals.
WeeklySchedule: JSON storing recommended hours for each activity per week.
YearlyMilestones: JSON storing targets for each year leading to the final goal.
RecommendedStrategies: Text describing effective strategies tailored to the user's needs.
SuccessProbability: Float representing estimated probability of achieving goals based on current data and analysis.
LastUpdated: Timestamp indicating when the plan was last modified.
S4.27 WordRetentionTests
Purpose: Logs results of regular word retention tests conducted to measure user progress in vocabulary retention.
Fields:
TestID (Primary Key)
UserID (Foreign Key to Users)
TestDate: Date when the test was conducted.
WordsRetained: Integer representing the number of words retained after testing.
S4.28 LearningEfficiencyMetrics
Purpose: Tracks individual user learning efficiency metrics over time, helping identify areas for improvement.
Fields:
UserID (Primary Key, Foreign Key to Users)
CalculationDate: Date when metrics were calculated.
AverageWordsRetainedAnnually: Integer representing average words retained annually based on tests.
TotalLearningTimeLastSixMonths: Float representing total hours spent on learning activities over the last six months.
EstimatedTimePerWord: Float representing average time spent learning and retaining one word in hours.
EfficiencyPercentile: Integer (1-10) indicating user's efficiency ranking compared to peers.
S4.29 System WideEfficiencyMetrics
Purpose: Stores system-level efficiency data, allowing comparisons across all users and identifying overall trends in learning effectiveness.
Fields:
CalculationDate: Date marking when metrics were calculated (Primary Key).
LowestEstimatedTimePerWord: Float representing the lowest average time spent learning and retaining a word across all users.
OptimalWeeklyHours: Float representing optimal weekly study hours based on system-wide analysis.
EfficiencyClusterData: JSON storing data related to all efficiency clusters formed from user analysis.
S5. Core Components and Interactions (New Additions)
S5.30 Longitudinal Predictor Analysis Engine
Purpose: Conducts long-term research to identify predictors of successful reading-based learning based on accumulated data over time.
Input:
Historical user data (demographics, learning behaviors, engagement metrics)
Long-term learning outcomes (e.g., reading proficiency levels, vocabulary growth rates)
System-wide performance metrics over time
Output:
Ranked list of predictors for successful reading-based learning
Statistical significance of each identified predictor
Correlation coefficients between predictors and long-term success metrics
Recommendations for improvements based on findings
Updated characteristic cluster definitions
Explanation: This engine analyzes years of accumulated data to find key user characteristics and behaviors that correlate with long-term success in reading-based learning. It uses advanced statistical techniques and machine learning algorithms to identify patterns and relationships in the data. The insights gained from this analysis inform improvements and help refine personalized learning strategies for users. By continuously updating its findings, the engine ensures that the system's recommendations and interventions remain relevant and effective as more data becomes available over time.
S5.31 Learning Achievement Predictor
Purpose: Predicts a user's future learning achievements based on current performance metrics and historical trends.
Input:
UserID
Current performance metrics (e.g., reading volume, vocabulary acquisition)
Historical learning data
Characteristic cluster assignments
Output:
Predicted achievements for 1, 2, and 3 years
Confidence intervals for predictions
Key influencing factors
Recommendations for strategy adjustments
Explanation: This function uses machine learning algorithms to forecast a user's future achievements, helping them set realistic goals and tailor their learning paths effectively.
S5.32 Goal-Oriented Learning Planner
Purpose: Generates personalized learning plans that help users achieve their specified reading-based learning goals within a given timeframe (G years).
Input:
UserID: Identifier for the user creating the learning plan.
User-defined goals: Specific reading-based learning objectives (e.g., vocabulary size, reading comprehension level).
Desired timeframe: The number of years (G) the user wishes to achieve their goals.
Current performance metrics: Data on the user's existing skills and learning behaviors.
Output:
Detailed personalized learning plan: A structured plan outlining weekly study schedules and yearly milestones.
Recommended strategies: Tailored learning strategies to help the user meet their goals.
Progress tracking metrics: Indicators to measure advancement toward goals over time.
Explanation: The Goal-Oriented Learning Planner creates actionable, personalized plans that guide users in achieving their language learning objectives. By analyzing user-defined goals and current performance metrics, it optimizes pathways with clear milestones and strategies, ensuring users stay focused and motivated throughout their learning journey.
S5.33 Optimal Learning Timeframe Estimator
Purpose: Estimates how long it will take a user to reach their vocabulary learning goals based on their current efficiency metrics and retention rates.
Input:
UserID: Identifier for the user whose timeframe is being estimated.
Vocabulary learning goals: The number of new words the user aims to acquire.
Current efficiency metrics: Data on the user's learning speed and retention rates.
System-wide efficiency data: Aggregate data on learning patterns and success rates across users.
Output:
Estimated optimal timeframe: The predicted duration (in years) required to achieve vocabulary goals.
Recommended weekly study hours: Suggested hours per week for effective learning.
Risk assessment: Indicators of potential breakeven points in learning.
Explanation: The Optimal Learning Timeframe Estimator analyzes both individual and system-wide efficiency data to provide users with a realistic estimate of how long it will take to achieve their vocabulary goals. It ensures that users maintain an effective learning pace, preventing situations where they forget more words than they learn, thus optimizing their overall language acquisition process.
S6. AI Integration (New Additions)
S6.5 Adaptive Predictor Identification
Purpose: Implements machine learning models that identify key predictors influencing successful reading-based learning outcomes over time.
Explanation: Uses statistical techniques like feature importance analysis to refine understanding of which characteristics lead to improved performance.
S6.6 Predictive Modeling for Learning Achievements
Purpose: Utilizes advanced forecasting methods to predict future achievements based on current and historical data trends.
Explanation: Employs time series analysis and ensemble methods to enhance prediction accuracy, allowing personalized goal-setting.
S6.7 AI-Driven Learning Path Optimization
Purpose: Optimizes personalized learning strategies using advanced algorithms that adapt based on user performance and engagement levels over time.
Explanation: Incorporates reinforcement learning and genetic algorithms to explore diverse strategies that maximize learning effectiveness.
S6.8 Learning Efficiency Optimization
Purpose: Develops models that predict word retention rates while optimizing the balance between new word acquisition and retention strategies tailored for individual users.
Explanation: Utilizes clustering techniques for grouping users by efficiency, allowing targeted recommendations based on best practices observed in high-achieving peers.
S7. User Interface (New Additions)
S7.24 User Characteristics Survey Interface
Purpose: Collects essential data regarding user characteristics necessary for personalized analysis and clustering efforts within the system.
Explanation: Provides an intuitive form where users can input information about their age, support systems, interests, etc., which will be used for tailoring recommendations.
S7.25 Longitudinal Research Dashboard
Purpose: Displays insights from long-term analyses regarding predictors of success in reading-based learning initiatives across users over time.
Explanation: Offers visualizations of predictor importance trends, aiding researchers and administrators in understanding effective strategies.
S7.26 Achievement Prediction Dashboard
Purpose: Provides users with forecasts regarding their potential future achievements based on current performance metrics and historical data patterns.
Explanation: Displays predicted growth trajectories along with confidence intervals, motivating continued engagement with personalized feedback.
S7.27 Goal-Oriented Learning Plan Dashboard
Purpose: Allows users to input specific goals and view their personalized learning plans generated by the system's algorithms.
Explanation: Displays detailed weekly schedules, yearly milestones, and progress tracking tools tailored toward achieving user-defined objectives effectively.
S7.28 Learning Efficiency Dashboard
Purpose: Shows users their current learning efficiency metrics compared against system-wide averages, along with optimal study recommendations based on collected data insights.
Explanation: Visualizes efficiency percentiles and offers actionable suggestions for improving study habits according to best practices identified within similar user groups.
S8. Application Logic (New Additions)
S8.7 AI-Driven User Characteristics Analysis
S8.7.1 Collect user characteristics data through the User Characteristics Survey Interface
S8.7.2 Store collected data in the UserCharacteristics table
S8.7.3 Perform AI-driven cluster analysis on user characteristics
S8.7.4 Assign users to characteristic clusters based on similarity
S8.7.5 Update user profiles with cluster assignments Explanation: This section describes how user characteristics are collected, stored, analyzed using AI-driven clustering techniques, and subsequently assigned into characteristic clusters that inform personalized strategies.
S8.8 Longitudinal Predictor Research
Explanation: This section details how regular analyses are conducted to identify predictors of success over time using accumulated historical data from users' interactions with the system.
S8.9 Learning Achievement Prediction
Explanation: This section outlines how predictive models are applied to forecast future achievements based on current performance metrics, allowing users insight into their potential growth trajectories.
S8.10 Goal-Oriented Learning Plan Generation
Explanation: This section describes how personalized plans are generated using AI algorithms tailored specifically towards helping users meet their individual educational objectives effectively.
S8.11 Optimal Learning Timeframe Estimation
Explanation: This section outlines how assessments are conducted regarding word retention rates among users while calculating optimal weekly study hours needed for vocabulary acquisition without hitting a breakeven point where forgetting exceeds new learnings.
S9. Data Flow (New Additions)
S9.18 User inputs characteristics data through User Characteristics Survey Interface
Explanation: Describes how user input is collected via an interface designed specifically for gathering essential characteristics information relevant for clustering analysis.*
S9.19 System stores characteristics data in UserCharacteristics table
Explanation: Indicates where collected characteristic data is stored within the database.*
S9.20 AI-Powered Characteristic Cluster Analyzer processes user characteristics data
Explanation: Details how AI processes this stored information through clustering algorithms.*
S9.21 System updates user profiles with characteristic cluster assignments
Explanation: Explains how profiles are updated post-clustering.*
This is the end of the detailed specifications for Reading-Based-Learning Strategy Analysis and Recommendation Tool Powered by AI—A Sub-System for the Reading-Based-Learning System Powered by AI (the Basic System).
   AI Agent Designed for Enhancing the Reading-Based-Learning System Facilitated with Word Pairs

This AI Agent is integrated with Word-Pair Facilitated Reading-Based-Learning System Powered by AI to function and is an added features of the system.

### Feature 1: Publication Search and Adaptation

The AI agent, ReadSmart Assistant, enhances the Reading-Based Learning System by autonomously sourcing, preparing, and optimizing reading materials for individual users.

### Core Functionalities:

1. Intelligent Publication Search:
   Searches online for suitable publications matching the reader's interests and learning goals.
   Prioritizes publications with high concentrations of “should-remember” words.
2. Copyright Management:
   Verifies copyright restrictions and calculates acquisition costs.
   Facilitates secure payments for rights or purchases upon user approval.
3. Publication Adaptation:
   Prepare publications for reading-based learning.
   Customizes adapted publications to user preferences.
4. Cost-Effectiveness Analysis:
   Evaluates the cost-benefit of acquiring and adapting publications.
   Provides recommendations to optimize costs while maintaining learning effectiveness.

### Feature 2: Real-Person Companion and Group Finder and Manager

The ConnectLearn agent searches for real individuals and groups engaged in reading-based-learning activities.

### Key Components:

1. Internet Search:
   Identifies potential companions and groups from various online platforms.
2. Recommendation System:
   Generates personalized recommendations based on user profiles.
   Uses matching algorithms for optimal compatibility.
3. Connection Facilitation:
   Assists in initial communication and group joining processes.
4. Collaborative Learning Activities:
   Schedules activities and recommends meeting platforms/venues.
   Manages payments for subscriptions or venue rentals.

### Feature 3: AI Learning Companion

This interactive agent enhances the reader's experience through various engaging activities:
1. Conversational Practice: Engages in text and voice chats about reading material.
2. Vocabulary Enhancement Games: Offers word games to reinforce learning
3. Contextual Learning Activities: Provides role-playing and writing exercises.
4. Pronunciation Coach: Offers pronunciation guidance and feedback.
5. Writing Assistant: Aids in writing tasks related to readings.
6. Progress Tracker: Monitors achievements and provides motivation.
7. Cultural Context Provider: Explains cultural references in texts.
8. Personalized Review Sessions: Creates custom quizzes and summaries.

### Feature 4: Parental Control and Guardian Oversight

This feature implements a robust control mechanism for non-adult learners:
1. Adult User Controls: Full decision-making authority for adult users.
2. Non-Adult User Management: Parental dashboard for monitoring and control.
3. Customizable Permissions: Parents can set specific access and usage limits.
4. Financial Controls: All payments require parental approval.
5. Activity Monitoring: Regular reports on child's learning progress.
6. Content Filters: Age-appropriate filters with parental customization.
7. Emergency Override: Instant session termination capability for parents.
8. Gradual Independence: Suggestions for increasing permissions as children age.

### Feature 5: System-Wide Knowledge Base

A centralized repository serving as a primary resource for all individual AI agents:
1. Centralized Repository: Stores information on publications, companions, and groups.
2. Prioritized Search Process: Agents query the knowledge base before external searches.
3. Knowledge Base Contribution: New information is added to the central knowledge base.
4. Categorization and Indexing: Organizes data for quick retrieval.
5. Version Control: Maintains historical data while updating with new information.
6. Access Control: Implements security measures to protect user data.
7. Performance Analytics: Tracks usage patterns and search efficiency.

### Feature 6: Resource and Connection Marketplace

Provides a need posting board for users to request resources and connections
Implements AI-powered matching algorithm for posts and potential collaborators
Offers customizable filters for incoming requests and offers
Includes a secure messaging system for user communication
Features a resource sharing hub with quality rating system
Provides activity organization tools integrated with system calendar
Implements privacy controls for user information sharing
Includes a feedback mechanism to improve future matching accuracy
   Integrating AI Services with Hybrid Architecture of Local AI on Reader Devices and Central Cloud AI for Reading-Based-Learning System Facilitated with Word Pairs

Beside the reading-based-learning system we presented earlier, now we present another system using AI for the reading-based-learning facilitated with word pairs: a Client-Server Architecture that has programming and AI function on both client side and server side.

What the local AI is supposed to do?

First collect and maintain the reader's reading data locally.

This local AI will have an eBook reader that generates the books for the reader based on the book generating process and data. When it is decided for the reader to read one book, the local AI will get an original book file from the central AI, and make it into a book for the reader to use locally. The generated book with word pair text layout will be stored both locally and centrally. The local AI will also deliver all the attached learning materials such as word lists to the reader.

This eBook reader will have some interaction functions with the reader: feelings, preferences, and situations, clicks to show his or her requests.

The reader can even write some suggestions, personal reading experiences and more to the AI system in the comments so that the AI will process them and do accordingly thereafter.

This eBook reader will record some other important reader's reading tracks such as each time the reading time and reading covered pages, etc.

The local AI has editing capability that can read what the reader writes and give feedback.

This local AI can also be a WORD.

The local AI has a video-to-text converter so that the reader can submit his or her retelling of what read to the converter and the AI will give feedback.

The local AI has a video meeting tool so that the reader can join online video discussion meetings. This tool must have meeting organizer, scheduling, and discussion time management functions. When possible, a virtual discussion moderator will be provided. The meeting organizer can have some sophisticated function that can find and maintain good meeting groups for the reader, with the meeting participants possibly from all over the world.

The local AI has a browser that will allow the reader to browse the internet, and renders the pages with word pairs inserted into the web pages pending on the reader's request. This will allow the reader to read a lot more from difference sources from all over the world.

Ideally, the local AI can also convert the books that the reader gets other sources than this reading system to be delivered with word pair text layout based on the reader's reading ability data stored locally. This feature of the local AI will facilitate the reader to read any book he or she may obtain from the world facilitated by word pair text layout.

The local AI gets pre-made knowledge from the central AI and gets regular update from the central AI.

The local AI send local data to central AI to get a fit of the reader to a pattern as recognized by the central AI, and then the local AI use this pattern to make prediction and do recommendations to the local reader.

The above are just the main features of the local AI should have. In reality there will be a lot more features that could be added.

What the central AI is supposed to do?

The central AI manages all the reader IDs so that readers can log on to their personal local AIs with ease. This is more like Apple ID management system.

The central AI can aggregate anonymized data from multiple local AIs, could then use this collective data to improve its own performance and knowledge base. The local AI can be connected to central AI for preset knowledge and regular updates. The central AI could periodically push updates to the local AIs, sharing new knowledge and improved models.

As such the central AI will be able to do cluster analysis all the time, and estimated the patterns for the clusters, which will give knowledge of good and bad reading strategies to the local AIs. So the local AI will take advantage of the central AI's knowledge and intelligence, to work with a reader combining with his or her local data. This is a personalization directed with global wisdom.

The central AI will store all the books in their originality.

The central AI will also keep track what individual readers read. The central AI does not need to keep all the converted books with word pairs according to each reader's situation, but keep a file containing the converting data such as the words in all the lists, their status and pages even lines so that the central AI keeps all the information regarding the converted books that all the readers read with just concise converting data for each book rather than a whole one.

The central AI connects all the local AIs so that all the readers in the system can get connected and do some communications among them.

Some requests from a reader may not be complete just by the local AI, one example is to create meaningful short articles containing the new words or any words that the reader wants to review intensively so that the reader can see the words in different contexts in short articles, or to get some process to speed up the naturalization of some newly learned words. The reader may give the local AI a list of words requesting to create a short article containing all these words. The local AI does not have that capacity and so the central AI can do it and then send back the created file to the local AI.

One of such schemes is to use AI to create short articles using the newly learned words so that the learner could be in the process to see the words used in different contexts.

Managing the newly learned words in consecutive readings is a natural way to speed up the process of naturalization.

There are many advantages of the architect of a hybrid central AI and local AIs, such as keeping sensitive user data on local devices, and local AIs do most of the work that reduces server load and latency.

Integrating a Screen Word Pair Adapter Module into the Reading-Base-Learning System
1. Screen Capture Function
implement a cross-platform screen capture library (e.g., Screenpresso API or TechSmith Capture SDK) to acquire content from various devices
Create a user interface for selecting the capture area and initiating the capture process
Support multiple content types: web pages, ebooks, chat contents, and other text-based materials
Implement OCR (Optical Character Recognition) to extract text from captured images.
2. Word Pair Adaptation Algorithm
Integrate the existing word pair adaptation algorithm with the captured content.
Implement a processing pipeline:
   a. Text extraction from captured content
   b. Application of word pair adaptation algorithm
   c. Formatting of adapted content for easy reading
Create a local storage system to save adapted content:
Use a database to store metadata and file references
Save adapted content as structured text files (e.g., markdown or HTML)
3. Background Processes for Content Advancement
Implement an asynchronous task queue for handling capture and adaptation processes
Create a content queue system to manage multiple captured screens or pages
Develop a progress tracking mechanism to monitor user reading progress and trigger new content captures
Hybrid Architecture Integration
Local AI Component:
Integrate screen capture and initial text processing
Implement local storage and retrieval of adapted content
Handle user interface for capture initiation and adapted content reading
Cloud AI Component:
Offload computationally intensive parts of the word pair adaptation algorithm
Provide advanced NLP processing for complex adaptations
Store and analyze usage data for system improvement
User Interface Enhancements
Add a “Capture Content” button to the main interface
Create a “My Adapted Content” section for accessing saved adaptations
Implement a reading interface for adapted content with navigation controls

So this concludes my efforts to draw a rough outline for a Hybrid Architecture of a local AI that runs on a reader's devices and a central AI that runs in the cloud for the Reading-Base-Learning System Facilitated with Word Pairs.

1: A method of laying out a perceptible presence of a network of relational target words (“review” words, “should-remember” words, “read-and-go” words, and “learn-to-use” words) in the text of publications in any language to become adapted publications with word pairs for improving reading smoothness and learning effectiveness, comprising:
1. Identifying, within a given text, a network of relational target words for:
1.1. An individual reader based on at least one of: the reader's vocabulary, recent reading history, reading preferences, and learning strategy; or
1.2. A group of readers based on the estimating typical vocabulary reservoir of the language for the readers at the determined proficiency level;
1.3. Wherein identifying the relational target words comprises:
1.3.1. Identifying all new words for the reader or readers in the text of the publication;
1.3.2. Determining “should-remember” words from the new words based on the reader's learning strategy or the readers' common advantageous strategy;
1.3.3. Designating remaining new words as “read-and-go” words;
1.3.4. Identifying “review” words by selecting a portion of recently learned words that also appear in the current text, thereby establishing a relationship between the current publication and the reader's or the readers' recent reading histories or the readers' common advantageous strategy;
1.3.5. Identifying “learn-to-use” words based on the reader's learning strategy or the readers' common advantageous strategy; and
1.3.6. Combining the identified category words to form the network of relational target words;
2. Categorizing the identified target words into one or more categories selected from a group consisting of:
2.1. A first category of “read-and-go” words,
2.2. A second category of “should-remember” words,
2.3. A third category of “review” words, and
2.4. A fourth category of “learn-to-use” words,
2.5. Wherein the number and types of categories applicable may vary based on the reader's or the readers' characteristics;
3. Finding a suitable equivalent to a target word to form a word pair, wherein:
3.1. If the text is written in the reader's or the readers' first language:
3.1.1. The equivalent and the target word are in the same language,
3.1.2. The equivalent is a simpler word known to the reader or readers, or
3.2. If the text is written in the reader's or readers' second language:
3.2.1. The equivalent is in the reader's or the readers' first language, and
3.2.2. The target word remains in the reader's or readers' second language as it appears in the text;
3.2.3. If needed for smoother reading and/or more efficient learning the equivalent can be a combination of words that may include words in the reader's or readers' second language and/or first language;
4. Categorizing all locations with target words in the text into two groups based on a word pair layout logic, the groups comprising:
4.1. A first group of locations designated as word pair locations, wherein target words at these locations will be replaced by corresponding word pairs; and
4.2. A second group of locations designated as non-word pair locations, wherein target words at these locations will not be replaced by word pairs;
5. Replacing target words at word pair locations with corresponding word pairs, wherein:
5.1. Each word pair comprises a target word and its equivalent;
5.2. Alternatively if preferred by the reader or readers, each word pair for the “read-and-go” words comprises only its equivalent without the corresponding “read-and-go” word;
5.3. The equivalent is positioned relative to its paired target word according to a word pair layout logic, wherein the position is selected from immediately after, immediately before, directly above, or directly below the target word;
5.4. Alternatively if preferred by the reader or readers, each word pair for the “read-and-go” words that only contains its equivalent without the corresponding “read-and-go” word, the equivalents replace their corresponding “read-and-go” words;
5.5. The positioning of the equivalent and the formatting of the word pairs are designed to minimize disruption to the reader's or the readers' visual flow of the text;
6. Laying out the text to create a perceptible presence of a network of relational target words in physical print or electronic media of the said adapted publication or publications, wherein:
6.1. Word pairs are visually designated according to a word pair marking logic;
6.2. Target words at non-word pair locations are distinctly marked based on a target word marking logic;
6.3. The marking methods may include, but are not limited to:
6.3.1. Color highlighting,
6.3.2. Underlining,
6.3.3. Bold or italic formatting,
6.3.4. Font size or type changes,
6.3.5. Leaving words unmarked as appropriate,
6.3.6. Same word in different positions may have different marks;
6.4. The marking logic considers factors such as:
6.4.1. The reader's or the readers' established word recognition patterns,
6.4.2. The reader's or the readers' new word memorizing habit,
6.4.3. The reader's or the readers' incidental learning capacity for new words,
6.4.4. The frequency and recency of word exposure within the text to the reader or the readers,
6.4.5. The cognitive load associated with different marking methods to the reader or the readers;
6.5. The layout ensures readability, facilitating learning, and aesthetic appeal while effectively emphasizing the relational target words.

2: The method of claim 1, wherein identifying, within a given text, a network of relational target words is extended to a series of publications, referred to as a relational publication set for long-term reading-based learning, the method further comprising:
1. sequentially selecting publications suitable for either the specific reader or readers at the target proficiency level, wherein:
1.1 the publications have a gradual increase in vocabulary difficulty and comprehension level,
1.2 the publications are intended for use over coming months and years,
1.3 priority is given to publications with higher concentrations of “should-remember” words from immediate earlier publications in the set, thereby facilitating review of recently learned words in reading rather than isolated memorization;
2. compiling the selected publications into a relational publication set;
3. analyzing word relations across the entire relational publication set;
4. identifying networks of relational target words for each publication within the set based on the reader's or readers' characteristics as specified in claim 1;
5. simultaneously determining the relational target words for each publication in the publication set or a subset, considering their relationships within and across the publications in the set for adjustments; and
6. applying the method of claim 1 to each publication in the relational publication set, wherein:
6.1 for a specific reader, the layout is tailored to their individual learning progress and needs,
6.2 for readers at a certain proficiency level, the layout is designed to accommodate the average needs and expected progress of readers at that level.

3: The method of claim 1, wherein finding a suitable equivalent to a target word to form a word pair when the text is written in the reader's or the readers' second language (Chinese) and the reader's or the readers' first language is English, Spanish, German, French, or any other language (L1) further comprises:
1. for a single Chinese character, forming a word pair as a concatenated string “[Pinyin] [Chinese character] [L1 equivalent]” without spaces or wrapping between elements;
2. for a multi-character Chinese word, forming the word pair by concatenating the word pairs of its individual characters using a delimiter selected from the group consisting of a dot, dash, underscore, or other suitable separator between adjacent character word pairs, and then appending an L1 equivalent of the entire multi-character word after a delimiter separating the concatenated character word pairs from the entire word's L1 equivalent, wherein elements may be concatenated with or without spaces or wrapping between elements as preferred by the reader or readers.

4: A database-driven system utilizing artificial intelligence for optimizing reading and vocabulary acquisition by laying out a perceptible presence of a network of relational target words in publications of any language, creating adapted publications with word pairs to improve reading smoothness and learning effectiveness, comprising:
1. A database configured to store:
1.1. A user's vocabulary stock, including all words and the total word count,
1.2. Reading comprehension level, such as using Lexile rating,
1.3. Reading preferences and goals, including weekly time commitment, reading volume targets, word increase targets, and book type preferences,
1.4. Reading history, and
1.5. New word acquisition progress;
2. A word identification and categorization module configured to:
2.1. Identify all new words for the reader in the text of the publication,
2.2. Determine “should-remember” words based on the reader's learning strategy,
2.3. Designate remaining new words as “read-and-go” words,
2.4. Identify “review” words by selecting a portion of recently learned words that also appear in the current text based on the reader's word review strategy,
2.5. Identify “learn-to-use” words based on the reader's active word learning strategy,
2.6. Combine the identified category words to form the network of relational target words;
3. a text layout module configured to:
3.1. Utilize AI language models to find suitable equivalents to target words to form word pairs, wherein:
3.1.1. if the text is in the reader's first language:
a) the equivalent and the target word are in the same language,
b) the equivalent is a simpler word known to the reader, and
c) the target word is not known to the reader;
3.1.2. if the text is in the reader's second language:
a) the equivalent is in the reader's first language, and
b) the target word remains in the reader's second language as it appears in the text;
3.1.3. If needed for smoother reading and/or more efficient learning the equivalent can be a combination of words that may include words in the reader's or readers' second language and/or first language;
3.2. categorize all locations with target words in the text into two groups based on a word pair layout logic:
a) word pair locations, where target words will be replaced by corresponding word pairs, and
b) non-word pair locations, where target words will not be replaced by word pairs;
3.3. replace target words at word pair locations with corresponding word pairs, wherein:
a) each word pair comprises a target word and its equivalent,
b) the equivalent is positioned relative to its paired target word according to a word pair layout logic, selecting from immediately after, immediately before, directly above, or directly below the target word,
c) the positioning and formatting of word pairs are designed to minimize disruption to the reader's visual flow;
3.4. lay out the text to create a perceptible presence of a network of relational target words in physical print or electronic media, wherein:
a) word pairs are visually designated according to a word pair marking logic,
b) target words at non-word pair locations are distinctly marked based on a target word marking logic,
c) apply marking methods including, but not limited to:
color highlighting,
underlining,
bold or italic formatting,
font size or type changes,
leaving words unmarked as appropriate,
applying different marks to the same word in different positions;
d) implement marking logic that considers factors such as:
the reader's established word recognition patterns,
the reader's new word memorizing habits,
the reader's incidental learning capacity for new words,
the frequency and recency of word exposure within the text,
the cognitive load associated with different marking methods;
e) ensure the layout maintains readability, facilitates learning, and preserves aesthetic appeal while effectively emphasizing the relational target words;
4. an optimization module configured to:
4.1. estimate a production function (the pattern of time allocated in the reading-based-learning activities and learning achievements) for the user based on reading gains and time commitments and allocations,
4.2. calculate comprehensive reading gains including vocabulary gains, reading volume, comprehension improvement, oral communication skills, written communication skills, and broadened horizons,
4.3. determine the optimal percentage of “read-and-go” words from previous readings to be included as “should-remember” words in subsequent readings,
4.4. adjust recommendations based on the estimated production function and user progress;
4.5. use AIs to get successful learning strategies of similar learners using the system to make further recommendations to a user or a group of users
5. a data analysis module integrating an AI configured to:
5.1. Prompt the AI to perform K-Means clustering analysis to identify reading patterns among users,
5.2. Prompt the AI to estimate production functions for each identified cluster of users using symbolic regression,
5.3. adapt to both small and large datasets as the system accumulates more user data over time;
6. a recommendation engine Integrating and AI configured to generate personalized reading assignments including:
6.1 a list of books to read and timeframes for completion,
6.2 lists of words in each category for each book,
6.3. weekly oral story-retelling assignments,
6.4. weekly small group discussions,
6.5. periodic written assignments;
7. a relational publication set module configured to:
7.1 sequentially select publications suitable for the reader's proficiency level,
7.2. compile the selected publications into a relational publication set for long-term reading-based learning,
7.3. analyze word relations across the entire relational publication set,
7.4 design publication sets for use over coming months and years,
7.5. gradually increase vocabulary difficulty and comprehension level across the set,
7.6 prioritize publications with higher concentrations of “should-remember” words from immediate earlier publications in the set;
8. an assessment module configured to:
8.1. administer “should-remember” word tests and reading comprehension tests after each book,
8.2. update the user's vocabulary stock and Lexile rating based on test results,
8.3. maintain historical records of word stocks and Lexile ratings for analysis;
9. a user interface configured to:
9.1. present or print adapted publications with marked target words and word pairs,
9.2. deliver word learning activities,
9.3. collect user feedback and test results,
9.4 allow users to adjust preferences and goals based on reading experiences.

5: The system of claim 4, wherein the optimization module is further configured an AI to:
1. use symbolic regression to capture non-linear and complex relationships between variables in the production function estimation;
2. adapt estimates based on accumulated user data over time;
3. consider the reader's preference for easier reading materials for more reading volume or average ones or slightly harder ones but less volume in the optimization process.

6: The system of claim 4, wherein the recommendation engine is further configured to:
1. provide off-reading-text word memorizing activities for “should-remember” words before, during, and after reading a book;
2. adjust recommendations based on the reader's performance in remembering “read-and-go” words without specific memorization activities;
3. incorporate “learn-to-use” words into weekly retelling oral exercises and monthly written exercises.

7: The system of claim 4, wherein the assessment module is further configured to:
1. test a portion of “read-and-go” words to evaluate incidental vocabulary acquisition;
2. assess retention of “reviewing” words to evaluate the effectiveness of spaced repetition;
3. provide adaptive testing based on the reader's progress and learning patterns.

8: The system of claim 4, wherein the data analysis module is further configured an AI to:
1. identify the best-fitted pattern of production function for new users based on initial data and existing user clusters;
2. make notable adjustments to the estimated production function for a reader after three to six months of data collection;
3. continuously refine the clustering analysis and production function estimates as more data is accumulated.

9: The system of claim 4, further comprising an AI agent that:
1. searches for and adapts publications based on user preferences, manages copyright, and analyzes cost-effectiveness;
2. identifies and recommends real-person learning companions and groups, facilitates connections, and manages collaborative activities;
3, functions as an interactive learning companion offering conversational practice, vocabulary games, contextual activities, writing assistance, progress tracking, and personalized reviews;
4. implements parental controls and guardian oversight for non-adult users;
5. utilizes a system-wide knowledge base for efficient information retrieval and contribution;
6. provides a marketplace for users to post resource needs and learning connection requests, with customizable filters and secure communication channels;
wherein the AI agent enhances the reading-based learning experience by providing personalized, efficient, and engaging features for users of all ages.

10: A hybrid artificial intelligence (AI) system for facilitating reading-based learning with word pairs, comprising:
1. A local combination of traditional programs and AI component running on a reader's device, configured to:
1.1. Collect and maintain the reader's reading data locally, including:
1.1.1. Reading time
1.1.2. Pages covered
1.1.3. Vocabulary progress
1.1.4. User preferences and feedback
1.2. Generate adapted eBooks with word pair layouts, including:
1.2.1. “Review” words
1.2.2. “Should-remember” words
1.2.3. “Read-and-go” words
1.2.4. “Learn-to-use” words
1.3. Provide interactive functions for reader engagement, such as:
1.3.1. Clicking to indicate remembered words
1.3.2. Marking unknown words
1.3.3. Requesting corrections for displayed word pairs
1.3.4. Submitting comments and suggestions
1.4. Offer writing assistance tools, including:
1.4.1. Editing capabilities with AI feedback
1.4.2. Native language word replacement with English equivalents
1.5. Implement a video-to-text converter for oral retelling exercises
1.6. Facilitate video meetings for group discussions
1.7. Provide a browser with word pair insertion capabilities for web pages
1.8. Convert externally sourced books to word pair layout format
1.9. Transmit collected data to the central AI regularly
1.10. Receive updates and instructions from the central AI
1.11. Provide a web browser function that:
1.11.1. Renders web pages
1.11.2. Adapts rendered web pages by inserting word pairs
1.11.3. Facilitates convenient reading of web content without the hurdle of new words with word pairs
1.11.4. Applies the same word pair layout logic used for eBooks to web pages
1.11.5. Allows users to interact with adapted web pages similarly to eBooks, including marking words and providing feedback
2. A local combination of traditional programs and AI component running in the cloud, designed to:
2.1. Manage reader IDs and authentication
2.2. Store original book files and reader-specific conversion data
2.3. Aggregate anonymized data from multiple local AIs
2.4. Perform cluster analysis on reading patterns
2.5. Estimate optimal reading strategies for different user clusters
2.6. Push periodic updates to local AIs, including:
2.6.1. New knowledge
2.6.2. Improved AI models
2.7. Generate short articles containing specified word lists for vocabulary reinforcement
2.8. Facilitate inter-reader communication and collaboration
3. A communication protocol between the local and central components, enabling:
3.1. Secure data transmission
3.2. Regular synchronization of user data
3.3. On-demand retrieval of central AI resources
3.4. Distribution of personalized reading recommendations
4. A personalization engine that combines:
4.1. Local user data
4.2. Global wisdom derived from central AI analysis
4.3. Cluster-based reading strategy recommendations
5. An eBook generation system that:
5.1. Retrieves original book files from the central AI
5.2. Applies word pair layouts based on individual reader profiles
5.3. Stores generated books both locally and centrally for convenient access
6. A vocabulary management system that:
6.1. Tracks newly learned words across consecutive readings
6.2. Implements a multi-stage review process for word retention
6.3. Adapts word categorization based on reader feedback and progress
7. A multi-modal learning support system, incorporating:
7.1. Writing improvement tools with AI-powered feedback
7.2. Speaking practice through video-to-text conversion and analysis
7.3. Reading comprehension enhancement via interactive eBook features
7.4. New words retention enhancement through AI-generated short articles and stories
8. A privacy-preserving architecture that:
8.1. Keeps sensitive user data on local devices
8.2. Uses anonymization techniques for data shared with the central AI
8.3. Implements secure communication protocols between local and central components

11: The hybrid artificial intelligence (AI) system of claim 10, further comprising a screen word pair adapter module configured to:
Implement a screen capture function for acquiring content from the reader's device and other compatible devices, including:
1.1. Capturing web pages, ebooks, chat contents, and other text-based materials
1.2. Utilizing optical character recognition (OCR) to extract text from captured images Apply the word pair adaptation algorithm to the captured content, including:
2.1. Processing the extracted text through the existing word pair adaptation pipeline
2.2. Formatting the adapted content for easy reading
2.3. Saving the adapted content to local storage for offline access
Execute background processes to handle content advancement and adaptation, including:
3.1. Implementing an asynchronous task queue for capture and adaptation processes
3.2. Managing a content queue system for multiple captured screens or pages
3.3. Tracking user reading progress to trigger new content captures as needed
Integrate with the existing hybrid architecture by:
4.1. Utilizing the local AI component for initial text processing and user interface management
4.2. Leveraging the cloud AI component for computationally intensive adaptations and advanced natural language processing
4.3. Synchronizing adapted content and usage data between local and cloud components
Enhance the user interface to support screen capture and adapted content reading, including:
5.1. Adding controls for initiating screen captures
5.2. Providing a dedicated section for accessing and managing saved adaptations
5.3. Implementing a reading interface for adapted content with navigation controls
Implement security and privacy measures for the adapted content, including:
6.1. Encrypting locally stored adapted content
6.2. Ensuring secure transmission of data between local and cloud components
6.3. Providing user controls for managing captured and adapted content.
